(19) United States
(12) Patent Application Publication
(10) Pub. No.: US 2002/0018291 A1
(43) Pub. Date: Feb. 14, 2002

(54) Microscope system

(76) Inventor: Hiroya Fukuyama, Sagamihara-shi (JP)

Correspondence Address: PILLSBURY WINTHROP LLP, 1600 TYSONS BOULEVARD, MCLEAN, VA, 22102, US

(21) Appl. No.: 09/917,839

(22) Filed: Jul. 31, 2001

(30) Foreign Application Priority Data
Aug. 1, 2000 (JP) 2000-237625

(51) Int. Cl. G02B 21/00; G02B 21/02; G02B 7/02

(52) U.S. Cl. 359/368; 359/383; 359/656; 359/814

(57) ABSTRACT

A microscope system has an objective unit including an objective lens, an objective holding device for holding the objective lens so that the objective lens can be spatially moved, at least one actuator for driving the objective lens, and an outer frame member for integrally supporting the objective lens, the objective holding device, and the actuator. Thus, an optical apparatus which is small in size, low in cost, and high in resolution can be obtained.

### BACKGROUND OF THE INVENTION

1. Field of the Invention

This invention relates to an objective unit used in the field of microscope, notably in an objective scanning microscope, an optical apparatus having the objective unit, and an observation method using the optical apparatus.

2. Description of Related Art

Scanning microscopes, as they are called, in which an image is obtained by scanning the surface of a specimen with a light beam have been studied from the past and have been put to practical use. As one type of these, there is a scanning microscope which uses a method by Martin R. Harris, disclosed in Japanese Patent Preliminary Publication No. Hie 3-87804. This microscope is a so-called beam scanning microscope in which a specimen and an objective lens are fixed so that the surface of the specimen is scanned with a light beam. For example, a laser beam emitted from a laser oscillator is introduced into a microscope body by an optical fiber and is incident on a microscope optical system through a scanner such as a galvanomirror. Whereby, the specimen is scanned with a light beam formed on the specimen, and signal light from the specimen is caused to follow a course opposite to that of illumination light so that the signal light is taken out by a light splitting means provided in the middle of the course and is detected by a photodetector.

A scanning microscope of another type is developed and published by Davidovits et al. (Paul Davidovids and M. David Egger, “Scanning Laser Microscope”, Nature, p. 831, Vol. 223, Aug. 23, 1969). This microscope is a so-called objective scanning microscope in which a specimen and an illumination beam are fixed so that the specimen is scanned with an objective lens. For example, a parallel laser beam with a larger diameter than the pupil diameter of the objective lens is introduced into the objective lens, which is driven in a direction normal to the optical axis, and thereby the specimen is scanned with the light beam. In this way, signal light from the specimen is condensed by an imaging lens and is detected by a photodetector.

In the scanning microscope using the Harris method, however, the entire system is costly and bulky because the laser oscillator and the photodetector are provided to be independent of the microscope body and the scanner and they are connected by the optical fiber. Moreover, the scanning microscope has a beam scanning system in which the objective lens is fixed, and thus, in order to observe a wide field, it is necessary to completely correct aberration of an optical system, notably of the objective lens, in a wide range from the optical axis to the top of an image height. However, the design of such a lens is not easy and is particularly difficult in the ultraviolet region in which glass material is highly limited in use.

In the scanning microscope using the Devidovits method, on the other hand, the system is to scan the specimen with the objective lens and thus a mechanism for driving the objective lens is required for the microscope body. Furthermore, since a structure for conducting the laser beam from the outside is incorporated, illumination for ordinary microscope observation and the changeover of the objective lens are not facilitated.

In addition, for the above conventional techniques, there is the problem of vibration, common to them, caused by a scan in a Z direction under a liquid-immersion observation. In the scan in the Z direction (namely a direction along the optical axis), it is necessary that the objective lens or a specimen stage is driven by an actuator not only in the objective scanning microscope but also in the beam scanning microscope. Hence, when a scanning speed is increased, vibration is transferred through an immersion liquid to the specimen in the case of the objective drive, or the specimen itself is subjected directly to the vibration in the case of the stage drive. This exerts an adverse influence on the observation. Also, it is needless to say that in the objective scanning microscope, the adverse influence is likewise exerted by a lens scan in an XY direction as well as in the Z direction.

In the field of neurophysiology, there is the need that a plurality of places separated from one another on a biological specimen should be observed simultaneously at a high magnification. For example, it is studied that signal transfer matter inside a nerve cell is marked by fluorescent dye to make fluorescence measurement and observation and thereby the condition of the transfer is observed. In the study of this type, there is a demand that a part to be stimulated and a plurality of places at distances of several millimeters to several tens of millimeters therefrom should be measured and observed simultaneously at high resolution.

With conventional, ordinary microscope and scanning microscope techniques, however, it is difficult to meet this demand. This is because when a high-NA objective lens is used to ensure the resolution, the visual field becomes narrow due to its high magnification, and thus the plurality of places to be observed cannot be captured, while a low-magnification and wide-field objective lens is used to bring these objects into the visual field, the resolution becomes poor due to its low NA. For example, a high-resolution objective lens with an NA of 0.7 or more (a resolution of about 0.5 μm) has a magnification as high as 20 or more, and therefore the visual field is so narrow that the diameter of the field on the specimen is as small as about 1 mm. In this state, the plurality of places at distances of several millimeters cannot be brought into the visual field. On the other hand, an objective lens with a magnification of approximately 1, having a wide field of nearly 20 mm in diameter, possesses low resolution of 0.04 NA (a resolution of around 8 μm), and hence necessary parts cannot be observed in detail.

### SUMMARY OF THE INVENTION

It is, therefore, a primary object of the present invention to provide an objective unit which is small in size, low in cost, and high in resolution and which is capable of facilitating the changeover to an ordinary microscope observation, an optical apparatus having the objective unit, and an observation method using the optical apparatus.

It is another object of the present invention to provide an objective unit which has functions of excluding an adverse influence of scanning vibration on an image under a liquid-immersion observation and observing a plurality of places separated from one another on a specimen at the same time and at a high magnification, an optical apparatus having the objective unit, and an observation method using the optical apparatus.

In order to achieve the above objects, the objective unit according to the present invention includes an objective lens, an objective holding means for holding the objective lens so that the objective lens can be spatially moved, at least one actuator for driving the objective lens, and an outer frame member for integrally supporting the objective lens, the objective holding means, and the actuator.

The optical apparatus having the objective unit according to the present invention is such that the objective unit includes an objective lens, an objective holding means for holding the objective lens so that the objective lens can be spatially moved, at least one actuator for driving the objective lens, and an outer frame member for integrally supporting the objective lens, the objective holding means, and the actuator.

The observation method using the optical apparatus provided with the objective unit according to the present invention is such that the optical apparatus has the objective unit including an objective lens, an objective holding means for holding the objective lens so that the objective lens can be spatially moved, at least one actuator for driving the objective lens, and an outer frame member for integrally supporting the objective lens, the objective holding means, and the actuator and is provided with a plane-parallel, transparent member at the top of the objective lens, so that spaces between the objective lens and the transparent member and between the transparent member and a specimen are filled with transparent liquid media of almost the same refractive index to observe the specimen.

These and other objects as well as features and advantages of the present invention will become apparent from the following detailed description of the preferred embodiments when taken in conjunction with the accompanying drawings.

### BRIEF DESCRIPTION OF THE DRAWINGS

FIG. 1 is a view showing schematically the entire construction of an objective scanning microscope which is the optical apparatus of a first embodiment in the present invention;

FIGS. 2A and 2B are plan and side views, respectively, showing the construction of an illumination and detection unit in the first embodiment;

FIG. 3 is a partially sectional view showing the structure of the frame of an objective unit in the first embodiment;

FIGS. 4A, 4B, and 4C are partially sectional plan, side, and bottom views, respectively, showing the specific structure of the objective unit in FIG. 3;

FIG. 5 is a block diagram showing a schematic construction of a control section in the first embodiment;

FIGS. 6A and 6B are diagrams showing the relationship between the objective pupil of a pupil plane and the illuminance distribution of an illumination beam in the first embodiment;

FIG. 7 is a view for explaining a modified example of the first embodiment;

FIGS. 8A and 8B are plan and side views, respectively, showing the construction of the illumination and detection unit of a second embodiment in the present invention;

FIG. 9 is a block diagram showing the schematic construction of the control section in the second embodiment;

FIGS. 10A and 10B are plan and side views, respectively, showing the construction of the illumination and detection unit of a third embodiment in the present invention;

FIG. 11 is a view for explaining essential parts of a modified example of the third embodiment;

FIG. 12 is a side view of the optical apparatus for explaining the illumination and detection unit of a fourth embodiment in the present invention;

FIG. 13 is a view showing a schematic construction of the illumination and detection unit of the fourth embodiment;

FIG. 14 is a view showing a schematic construction of the illumination and detection unit of a fifth embodiment in the present invention;

FIG. 15 is a side view of the optical apparatus for explaining the illumination and detection unit of a sixth embodiment in the present invention;

FIG. 16 is a view showing a schematic construction of the illumination and detection unit of the sixth embodiment;

FIG. 17 is a view showing schematically the arrangement of optical elements used in the optical apparatus of the sixth embodiment;

FIG. 18 is a view showing a schematic structure of the objective unit of a seventh embodiment in the present invention;

FIG. 19 is a view showing a schematic structure of the objective unit of an eighth embodiment in the present invention;

FIG. 20 is an explanatory view showing the objective unit of a ninth embodiment in the present invention;

FIG. 21 is an explanatory view showing the objective unit of a tenth embodiment in the present invention;

FIG. 22 is an explanatory view showing the objective unit of an eleventh embodiment in the present invention;

FIG. 23 is an explanatory view showing essential parts of FIG. 22;

FIG. 24 is an explanatory view showing the objective unit of a twelfth embodiment in the present invention;

FIG. 25 is an explanatory view showing the objective unit of a thirteenth embodiment in the present invention;

FIG. 26 is a conceptual view for explaining the function of the optical apparatus of a fourteenth embodiment in the present invention;

FIG. 27 is a view showing schematically the construction of the entire optical system of the fourteenth embodiment; and

FIG. 28 is an explanatory view showing the relationship among the objective pupils of the pupil plane, apertures of a photometric system, and illumination beams.

### DETAILED DESCRIPTION OF THE PREFERRED EMBODIMENTS

Before undertaking the description of the embodiments, it will be expedient to explain the function and effect of the present invention.

According to the present invention, only an axial beam of light is condensed and thus a spot of light in which aberration is minimized can be formed. Where the objective unit is mounted to the optical apparatus to construct a scanning optical apparatus, a scanning mechanism is not required for the optical apparatus itself, and therefore the entire optical apparatus can be downsized.

According to the present invention, the objective unit, like an ordinary objective lens, can be mounted to the revolver of the optical apparatus. Hence, when the objective unit is placed in the optical path, the optical apparatus functions as a scanning microscope, while when the ordinary objective lens is placed in the optical path, it functions as a conventional optical microscope.

According to the present invention, even when a space between the objective lens and the specimen is filled with a liquid, vibration caused by the scan of the objective unit is blocked by the transparent member and do not reach the specimen, and thus the specimen is not subject to the vibration. As such, a sharp image of the specimen can be obtained. Moreover, as described above, the objective unit, like an ordinary objective lens, can be mounted to the revolver of the optical apparatus. Hence, when the objective unit is placed in the optical path, the optical apparatus functions as a scanning microscope, while when the ordinary objective lens is placed in the optical path, it functions as a conventional optical microscope.

It is favorable that the objective unit of the present invention includes an element which combines a light emitter with a photodetector and a relay optical system which introduces light from the element into the objective lens and at the same time, introduces again signal light from the specimen, passing through the objective lens, into the element.

According to this aspect, the objective unit is provided with a light source, a scanning mechanism, and a photodetector, and thus, only by mounting the objective unit to the optical apparatus, the scanning optical apparatus can be constructed.

It is desirable that the objective unit of the present invention includes a light source, a photodetector, and light splitting and combining member which introduces light from the light source into the objective lens and introduces signal light passing through the objective lens into the photodetector.

According to this aspect, as in the above description, the objective unit is provided with the light source, the scanning mechanism, and the photodetector, and thus, only by mounting the objective unit to the optical apparatus, the scanning optical apparatus can be constructed. Since the light source is constructed to be independent of the photodetector, signal light, such as fluorescent light, having a wavelength different from that of the light source can be detected.

It is desirable that the objective unit of the present invention is provided with three sets of actuators so that a first actuator is placed to move the objective lens in a first direction, a second actuator is placed to move the objective lens in a second direction different from the first direction, and a third actuator is placed to move the objective lens in a third direction different from each of the first and second directions.

According to this aspect, the spot of light can be moved in a plane normal to the optical axis and along the optical axis, and the three-dimensional information of the specimen can be obtained.

It is desirable that the objective unit of the present invention is designed so that the outer frame member has a plane-parallel, transparent member, which is placed at the top of the objective lens.

According to this aspect, even when a space between the objective lens and the specimen is filled with a liquid, vibration caused by the scan of the objective unit is blocked by the transparent member and do not reach the specimen, and thus the specimen is not subject to the vibration. As such, a sharp image of the specimen can be obtained.

It is favorable that the objective unit of the present invention is constructed so that the objective holding means holds a plurality of objective lenses.

According to this aspect, since a plurality of regions located at separate positions on the specimen are scanned simultaneously by the plurality of objective lenses, images in the plurality of regions can be formed at a time. For example, this is suitable for measurement of signal transfer inside the nerve cell in the field of neurophysiology.

It is favorable that the objective unit of the present invention is designed so that the outer frame member has a plurality of units, each including an objective lens, an objective holding means, and an actuator.

According to this aspect, in the case of a synchronous scan by a plurality of objective lenses, like the above description, a plurality of regions located at separate positions on the specimen are scanned simultaneously by the plurality of objective lenses, and thus images in the plurality of regions can be formed at a time. In the case of an individual scan, since the speed and width of the scan can be changed with respect to each of the objective lenses, spatial resolution and the S/N ratio are considered in accordance with an object to be observed so that an image can be obtained with the optimum scanning condition.

In the optical apparatus of the present invention, it is desirable that the objective unit includes an element which combines a light emitter with a photodetector and a relay optical system which introduces light from the element into the objective lens and at the same time, introduces again signal light from the specimen, passing through the objective lens, into the element.

According to this aspect, like the above description, the objective unit is provided with the light source, the scanning mechanism, and the photodetector, and thus, only by mounting the objective unit to the optical apparatus, the scanning optical apparatus can be constructed.

Also, as mentioned above, the objective unit, like an ordinary objective lens, can be mounted to the revolver of the optical apparatus. Hence, when the objective unit is placed in the optical path, the optical apparatus functions as a scanning microscope, while when the ordinary objective lens is placed in the optical path, it functions as a conventional optical microscope.

In the optical apparatus of the present invention, it is desirable that the objective unit includes a light source, a photodetector, and a light splitting and combining member which introduces light from the light source into the objective lens and introduces signal light passing through the objective lens into the photodetector.

According to this aspect, as described above, the objective unit is provided with the light source, the scanning mechanism, and the photodetector, and thus, only by mounting the objective unit to the optical apparatus, the scanning optical apparatus can be constructed. Since the light source is constructed to be independent of the photodetector, signal light, such as fluorescent light, having a wavelength different from that of the light source can be detected.

Also, as mentioned above, the objective unit, like an ordinary objective lens, can be mounted to the revolver of the optical apparatus. Hence, when the objective unit is placed in the optical path, the optical apparatus functions as a scanning microscope, while when the ordinary objective lens is placed in the optical path, it functions as a conventional optical microscope.

It is favorable that the optical apparatus of the present invention is provided with three sets of actuators so that a first actuator is placed to move the objective lens in a first direction, a second actuator is placed to move the objective lens in a second direction different from the first direction, and a third actuator is placed to move the objective lens in a third direction different from each of the first and second directions.

According to this aspect, the spot of light can be moved in a plane normal to the optical axis and along the optical axis, and the three-dimensional information of the specimen can be obtained.

Also, as mentioned above, the objective unit, like an ordinary objective lens, can be mounted to the revolver of the optical apparatus. Hence, when the objective unit is placed in the optical path, the optical apparatus functions as a scanning microscope, while when the ordinary objective lens is placed in the optical path, it functions as a conventional optical microscope.

It is desirable that the optical apparatus of the present invention is provided with an illumination and detection unit having an element which combines a light emitter with a photodetector and a relay optical system which introduces light from the element into the objective lens and at the same time, introduces again signal light from the specimen, passing through the objective lens, into the element.

As in this aspect, when the light source is constructed to function also as the detector, a light splitting and combining member to be described below becomes unnecessary, and compactness of the illumination and detection unit can be achieved.

It is favorable that the optical apparatus of the present invention is provided with an illumination and detection unit having a light source, a photodetector, and the light splitting and combining member which introduces light from the light source into the objective lens and introduces signal light passing through the objective lens into the photodetector.

In the optical apparatus of the present invention, it is favorable that the illumination and detection unit is provided with a path switching means which introduces illumination light into the objective unit and at the same time, introduces signal light into the detector and a path switching means moving mechanism which inserts or removes the path switching means in or out of the optical path.

According to this aspect, a scanning optical microscope observation and a conventional microscope observation can be switched over to each other.

In the optical apparatus of the present invention, it is desirable that the optical apparatus has an imaging lens for condensing a parallel beam and the illumination and detection unit is placed on the exit side of the imaging lens.

According to this aspect, an image under the scanning optical microscope can be obtained, leaving the optical path for a camera as it is.

It is desirable that the optical apparatus of the present invention is constructed so that light incident on the objective lens satisfies the following condition:

I_{off}/Iₒₙ≧0.135 (1)

where Iₒₙ is a light intensity at the center of illumination light and I_{off} is a light intensity at the position of a radius of d+Dp/2 from the center of the illumination light (where Dp is the pupil diameter of the objective lens and d is the maximum amount of movement of the objective lens moved by the actuator, that is, a distance from the center of the illumination light to the optical axis of the objective lens).

According to this aspect, the illumination light has a sufficient intensity in the range of movement of the objective lens even in the case of single objective lens or a plurality of objective lenses, and therefore an illumination beam is introduced into the pupil of the objective lens, without shortage of the amount of light. Consequently, the resolution and the illumination intensity (the amount of illumination light) can be prevented from lowering extremely.

In the optical apparatus of the present invention, it is desirable that a plane-parallel, transparent member is placed at the top of the objective lens.

According to this aspect, as described above, even when a space between the objective lens and the specimen is filled with a liquid, vibration caused by the scan of the objective unit is blocked by the transparent member and do not reach the specimen, and thus the specimen is not subject to the vibration. As such, a sharp image of the specimen can be obtained.

Also, as mentioned above, the objective unit, like an ordinary objective lens, can be mounted to the revolver of the optical apparatus. Hence, when the objective unit is placed in the optical path, the optical apparatus functions as a scanning microscope, while when the ordinary objective lens is placed in the optical path, it functions as a conventional optical microscope.

It is desirable that the optical apparatus of the present invention is constructed so that the objective holding means holds a plurality of objective lenses, and a light source for producing a light beam which is incident as illumination light on all the plurality of objective lenses, and a plurality of photodetectors.

According to this aspect, as mentioned above, since a plurality of regions located at separate positions on the specimen are scanned simultaneously by the plurality of objective lenses, images in the plurality of regions can be formed at a time. For example, this is suitable for measurement of signal transfer inside the nerve cell in the field of neurophysiology.

Also, as mentioned above, the objective unit, like an ordinary objective lens, can be mounted to the revolver of the optical apparatus. Hence, when the objective unit is placed in the optical path, the optical apparatus functions as a scanning microscope, while when the ordinary objective lens is placed in the optical path, it functions as a conventional optical microscope.

In the optical apparatus of the present invention, it is favorable that the outer frame member has a plurality of units, each including an objective lens, an objective holding means, and an actuator.

According to this aspect, in the case of a synchronous scan by the plurality of objective lenses, like the above description, a plurality of regions located at separate positions on the specimen are scanned simultaneously by the plurality of objective lenses, and thus images in the plurality of regions can be formed at a time. In the case of an individual scan, since the speed and width of the scan can be changed with respect to each of the objective lenses, spatial resolution and the S/N ratio are considered in accordance with an object to be observed so that an image can be obtained with the optimum scanning condition.

Also, as mentioned above, the objective unit, like an ordinary objective lens, can be mounted to the revolver of the optical apparatus. Hence, when the objective unit is placed in the optical path, the optical apparatus functions as a scanning microscope, while when the ordinary objective lens is placed in the optical path, it functions as a conventional optical microscope.

In accordance with the drawings, the embodiments of the present invention will be described below.

First Embodiment

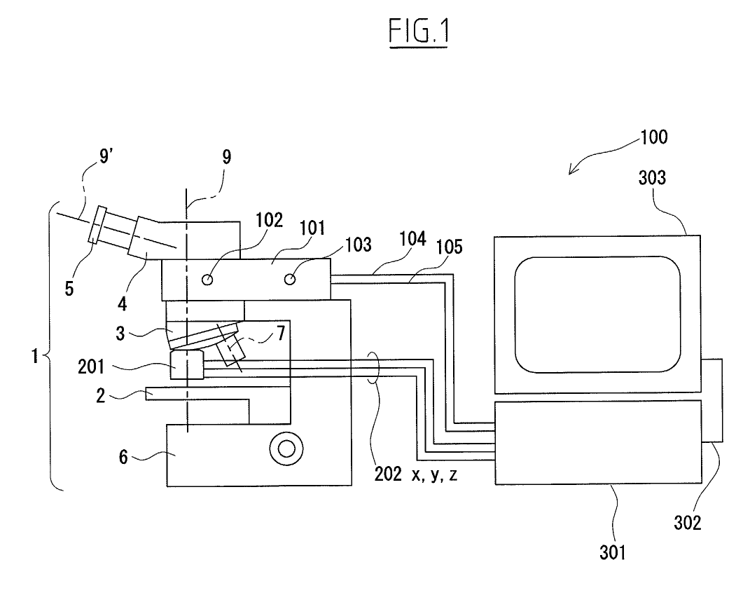

The first embodiment of the optical apparatus having the objective unit of the present invention is explained with reference to FIG. 1 through FIGS. 6A and 6B. The optical apparatus of this embodiment is a laser scanning microscope suitable for observations of industrial materials and products, such as semiconductors and metals, that is, a so-called LSM.

An objective scanning microscope 100 which is the optical apparatus of the present invention, as shown in FIG. 1, is constructed with an illumination and detection unit 101 having a light source and a photodetector; an objective unit 201 having an objective lens and an actuator for moving the objective lens in a scan; an optical microscope body 1 provided with the illumination and detection unit 101 and the objective unit 201; a control section 301 for controlling the light source and the actuator and at the same time, producing an image signal in accordance with a signal from the photodetector; and a monitor 303 for displaying an image.

The microscope body 1 has an objective lens 7, a lens barrel 4, and an eyepiece 5 in order to make an ordinary observation. A revolver 3 is operated to align the objective lens 7 with respect to an optical path 9, and a knob 102 to be described later is operated to move an optical element inside the illumination and detection unit 101 so that the optical path 9 assumes a tunnel-like shape in the range from the objective lens 7 to the lens barrel 4. In this way, the ordinary observation can be carried out. Also, in FIG. 1, reference numeral 2 represents a stage, 6 represents a base, and 9′ represents an observation optical path going through the eyepiece 5.

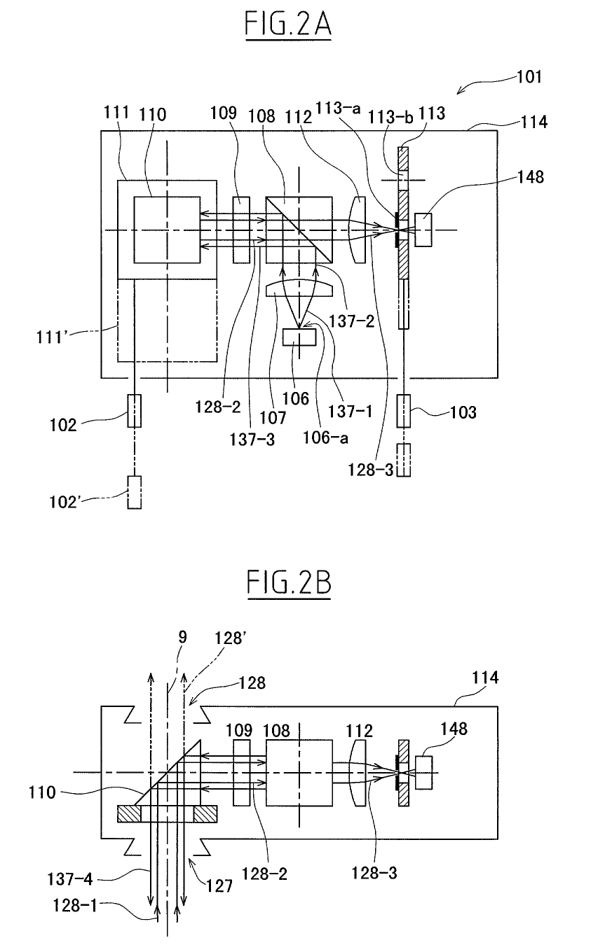

The illumination and detection unit 101, as shown in FIG. 2A, includes a semiconductor laser oscillator 106, a collimator lens 107, a polarization beam splitter 108, a quarter-wave plate 109, a rectangular prism 110 provided with a path switching member 111, a condenser lens 112, a confocal/non-confocal switching member 113 having a confocal pinhole 113-a, and a silicon photodiode 148. The semiconductor laser oscillator 106 is designed to emit divergent light 137-1 with the wavelength of infrared, red, green, blue, or purple light, determined in accordance with its application.

In the illumination and detection unit 101, the divergent light 137-1, when emitted from the semiconductor laser oscillator 106, changes through the collimator lens 107 to a parallel beam 137-2, which is incident on the polarization beam splitter 108. The beam is reflected by the reflecting surface of the polarization beam splitter 108, and thereby becomes a linearly polarized beam 137-3, which is incident on the quarter-wave plate 109. The quarter-wave plate 109 is mounted so that its optic axis is oriented at an angle of 45° with the direction of vibration of polarization of the linearly polarized beam 137-3. The linearly polarized beam 137-3 is transmitted through the quarter-wave plate 109, and thereby becomes a circularly polarized beam 137-4, which enters the rectangular prism 110 mounted on the path switching member 111. The circularly polarized beam 137-4 incident on the rectangular prism 110, as shown in FIG. 2B, is reflected by the reflecting surface of the rectangular prism 110 and emerges from a lower aperture 127 provided on an outer cover 114 to illuminate a point on the specimen through an objective lens, not shown.

This illumination light is reflected and scattered by the specimen and is returned as a circularly polarized beam 128-1 of signal light which follows the same optical path as in the illumination light. Specifically, the circularly polarized beam 128-1, after being incident from the lower aperture 127, is reflected by the reflecting surface of the rectangular prism 110 and is transmitted through the quarter-wave plate 109. The signal light 128-2 transmitted through the quarter-wave plate 109 passes twice through the quarter-wave plate 109: once in a state of the illumination light 137-2 which is the parallel beam before being reflected by the specimen, and once in a state of the signal light 128-1 which is a circularly polarized beam after being reflected by the specimen. Consequently, the signal light changes to a linearly polarized beam 128-2.

In this case, the linearly polarized beam 128-2 is such that the direction of vibration of its linearly polarized component is perpendicular to that of the linearly polarized component of the linearly polarized beam 137-3. Thus, the beam 128-2 is transmitted through the polarization beam splitter 108 and changes to a convergent beam 128-3 through the condenser lens 112 so that an image (small light spot) is formed on the confocal pinhole 113-a provided on the confocal/non-confocal switching member 113.

The confocal pinhole 113-a is constructed as a confocal optical system, together with an exit port 106-a of the semiconductor laser oscillator 106. Consequently, of the convergent beam 128-3 which is the signal light, only a focusing component is transmitted through the confocal pinhole 113-a and is converted through the silicon photodiode 148 into a photoelectric signal.

The confocal/non-confocal switching member 113, in addition to the confocal pinhole 113-a, is provided with a non-confocal aperture 113-b which has a sufficient size to transmit a defocusing component in the signal light. By operating a knob 103 associated with the switching member 113, the confocal pinhole 113-a or the non-confocal aperture 113-b is selected at will and can be positioned on the optical path of the signal light, that is, so that the confocal optical system and a non-confocal optical system can be switched over to each other.

The rectangular prism 110 can be freely inserted in or removed out of the optical path 9 of the microscope body by operating the knob 102 associated with the path switching member 111. In FIG. 2A, when the rectangular prism 110 is inserted in the optical path 9 (namely when the knob and the path switching member are located at the positions of solid lines indicated by the reference numerals 102 and 111, respectively, in this figure), the rectangular prism 110 functions as described above. On the other hand, when the rectangular prism 110 is removed out of the optical path 9 (namely when they are located at the positions of two-dot chain lines indicated by reference numerals 102′ and 111′), the optical path 9 assumes a tunnel-like shape between the lower aperture 127 and an upper aperture 128, and thus the ordinary observation can be carried out through the objective lens 7, the lens barrel 4, and the eyepiece 5 in FIG. 1. Also, reference numeral 128′ denotes reflected light from the specimen in the ordinary observation.

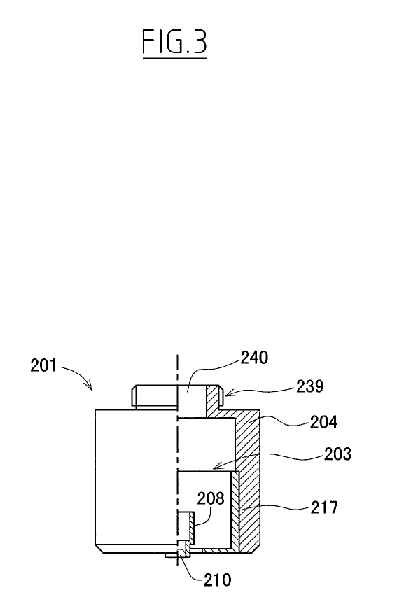

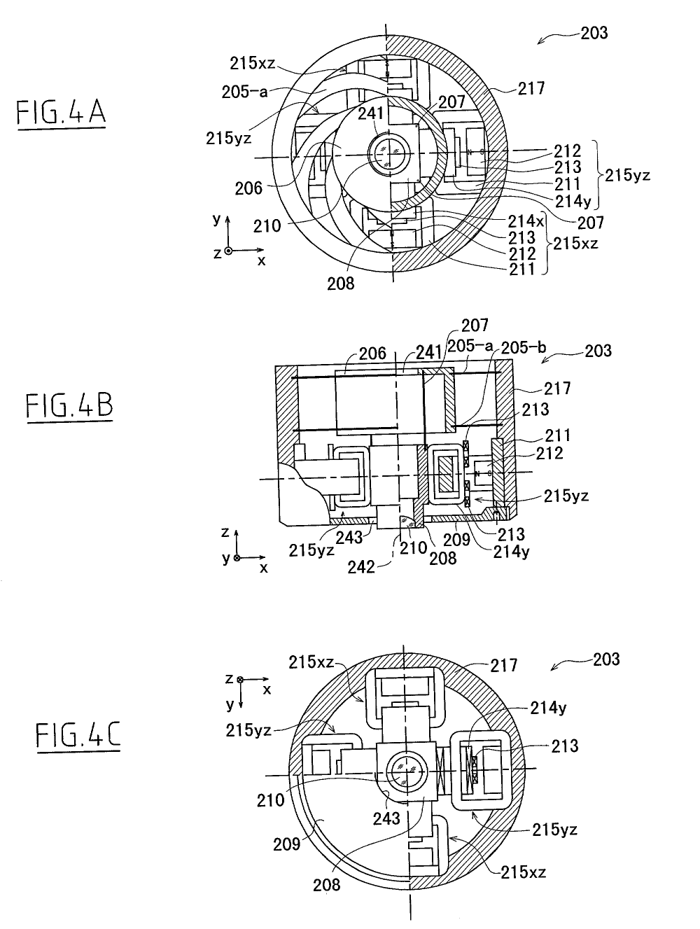

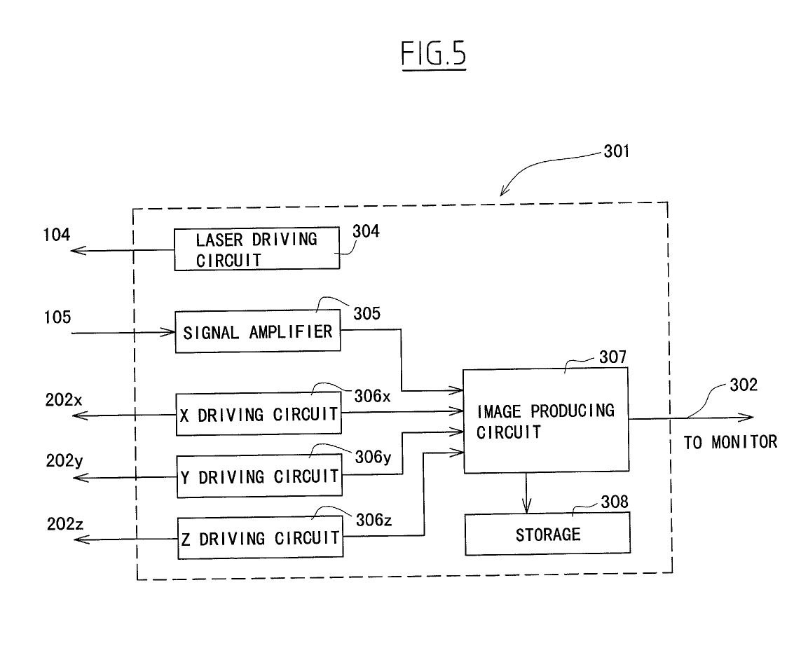

The objective unit 201, as illustrated in FIGS. 3 and 4A-4C, includes an outer frame 204, an inner frame 217, an objective lens 210, an objective frame 208, parallel springs 207, an intermediate support 206, spiral plate springs 205-a and 205-b, and VCMs (voice coil motors) 215yz and 215xz. The outer frame 204, as shown in FIG. 3, has a male screw 239 for mounting the objective unit 201 to the revolver 3 shown in FIG. 1 and an aperture 240, and holds an objective component 203 composed of the inner frame 217 and others, shown in FIGS. 4A-4C (however, in FIG. 3, the interior of the objective component 203 is omitted).

The inner frame 217, as shown in FIGS. 4A and 4B, elastically holds the intermediate support 206 through the two sets of spiral plate springs 205-a and 205-b, arranged in parallel, and regulates the movement of the intermediate support 206 so that it can be moved in a Z direction only.

The intermediate support 206 has an aperture 241 for an optical path. The intermediate support 206 elastically holds the objective frame 208 through the four bar-shaped parallel springs 207, each made with an elastic body, and regulates the movement of the objective frame 208 so that it can be moved in an XY direction with respect to the intermediate support 206. Consequently, the objective frame 208 and the objective lens 210 fixed thereto, although not moved in the direction of rotation with respect to the inner frame 217, is elastically held so that they can be freely moved in an XYZ direction.

The inner frame 217, as shown in FIGS. 4A and 4C, has two VCMs 215xz for driving the objective frame 208 in the XZ direction and two VCMs 215yz for driving the objective frame 208 in the YZ direction. The VCM 215xz and the VCM 215yz are biaxial actuators of the same structure which are different in direction of mounting to the inner frame 217 from each other. Each of them, as shown in FIG. 4A, is constructed with a permanent magnet 212, a yoke 211, two Z-direction driving coils 213 (see FIG. 4B), and an X- or Y-direction horizontal driving coil. In the XZ-direction driving VCM 215xz, this horizontal driving coil corresponds to an X-direction driving coil 214x, while in the YZ-direction driving VCM 215yz, it corresponds to a Y-direction driving coil 214y.

The two XY-direction driving VCMs 215xz are such that electromagnetic forces generated in the X-direction driving coils 214x coincide with each other in the X direction and electromagnetic forces generated in the two Z-direction driving coils 213 coincide with each other in the Z direction, and the VCMs 215xz are located at opposite positions with respect to an optical axis 242. The X-direction driving coils 214x, together with the two Z-direction driving coils 213, are fixed to the objective frame 208.

The two YZ-direction driving VCMs 215yz, like the two XZ-direction driving VCMs 215xz, are such that electromagnetic forces generated in the Y-direction driving coils 214y coincide with each other in the Y direction and electromagnetic forces generated in the two Z-direction driving coils 213 coincide with each other in the Z direction, and the VCMs 215yz are located at opposite positions with respect to the optical axis 242. The Y-direction driving coils 214y, together with the two Z-direction driving coils 213, are fixed to the objective frame 208.

In the first embodiment, since the objective unit 201 is constructed as mentioned above, the XZ-direction driving VCMs 215xz and the YZ-direction driving VCMs 215yz are driven, and thereby the position of the objective lens 210 can be controlled in such a way that the objective lens 210 is moved independently in any of the directions of three axes of X, Y, and Z.

The bottom of the inner frame 217, as shown in FIG. 4B, is fitted with a cover 209, and as shown in FIG. 4C, the objective frame 208 protrudes from an aperture 243 provided at the middle of the cover 209. The aperture 243 is larger than the diameter of the top of the objective frame 208 so that even in the case of the scan by the objective frame 208, the cover 209 does not come in contact with the top of the objective frame 208.

The control section 301, as shown in FIG. 5, includes a laser driving circuit 304, a signal amplifier 305, an X driving circuit 306x, a Y driving circuit 306y, a Z driving circuit 306z, an image producing circuit 307, and a storage device 308.

The laser driving circuit 304 is constructed to drive the semiconductor laser oscillator 106 in the illumination and detection unit 101, shown in FIG. 2A, through a cable 104. The signal amplifier 305 is constructed to amplify a signal current from the silicon photodiode 148 in the illumination and detection unit 101 through a cable 105. The X driving circuit 306x, the Y driving circuit 306y, and the Z driving circuit 306z are designed to drive the X-direction driving coils 214x, the Y-direction driving coils 214y, and the Z-direction driving coils 213 in the objective unit 201, shown in FIG. 4A, through X-, Y-, and Z-direction driving cables 202x, 202y, and 202z, respectively.

The image producing circuit 307 produces an image signal from an amplifying signal delivered from the signal amplifier 305 and driving signals delivered from the X driving circuit 306x, the Y driving circuit 306y, and the Z driving circuit 306z, and applies image processing, such as filtering, when the necessity arises, so as to output a display signal to the monitor 303 shown in FIG. 1 through a monitor cable 302, or to the storage device 308. The storage device 308 stores the image signal produced by the image producing circuit 307, as image information, into a memory means, such as a semiconductor memory, a magnetic disk, or a Magneto-Optical disk.

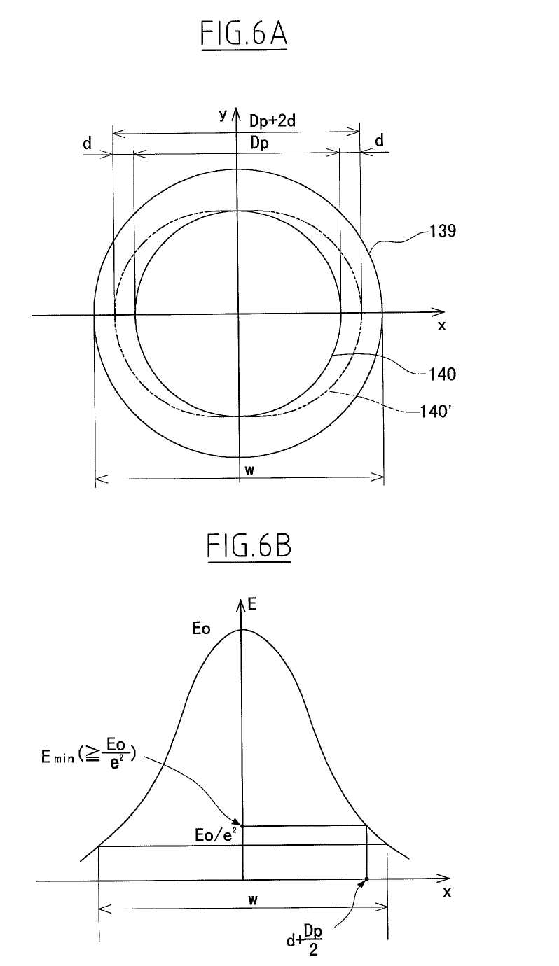

Now, reference is made to the relationship between a pupil of the objective lens (hereinafter referred to as an objective pupil) in a pupil plane and the illuminance distribution of an illumination beam in the first embodiment. As depicted in FIGS. 6A and 6B, the intensity distribution of an illumination beam 139 is a Gaussian distribution with a beam diameter W. The diameter W of the illumination beam 139 is a contour diameter in which the intensity of light becomes Eo/e² (that is, 0.135Eo) with respect to an intensity Eo at the center of the beam. Reference numeral 140 denotes an area where light passes through the objective lens when the scan is stopped, and a diameter Dp of the area 140 is the same as the diameter of the objective pupil. On the other hand, numeral 140′ also denotes an area where the light passes through the objective lens, but in this case, the scan with the objective lens is carried out with a scanning width 2d in the X direction. In the first embodiment, the illumination beam is introduced into the objective pupil over an elliptical region indicated by the pupil 140′. Since this region is included in the range of the beam diameter W, an intensity Eₘᵢₙ is at least Eo/e² even at the position where the intensity is lowest in the objective pupil, that is, at the position of d+Dp/2. As mentioned above, the illumination light is adapted to maintain a sufficient intensity, at least, within the range of movement of the objective lens. Consequently, the illumination beam is introduced into the objective pupil, without eclipse of the bundle of light.

Subsequently, a description will be given of the function of an optical apparatus having the objective unit of the first embodiment constructed as mentioned above. Through the laser driving circuit 304 in the control section 301 shown in FIG. 5, the laser oscillator 106 in the illumination and detection unit 101 of FIG. 2A is driven, and the divergent light 137-1 is emitted from the laser oscillator 106. In this case, the emitted divergent light 137-1 changes to the circularly polarized beam 137-4 through the collimator lens 107, the polarization beam splitter 108, the quarter-wave plate 109, and the rectangular prism 110, and emerges from the lower aperture 127 shown in FIG. 2B. The beam, after entering the objective unit 201 mounted to the revolver 3 shown in FIG. 1, is incident, through the apertures 240 and 241 in FIGS. 3, 4A, and 4B, on the objective lens 210 in FIG. 4C, and is converged on the specimen placed on the stage 2 in FIG. 1.

The signal light scattered and reflected by the specimen follows an opposite course to the illumination light to return to the illumination and detection unit 101, and is transmitted through the quarter-wave plate 109 in FIG. 2A, becoming the linearly polarized beam 128-2. The beam is then transmitted through the polarization beam splitter 108 and is focused through the condenser lens 112 on the confocal pinhole 113-a. Since, in this case, the confocal pinhole 113-a is located at a confocal position, only the focusing component of the signal light is transmitted through this pinhole and is converted through the silicon photodiode 148 into a photoelectric signal. The photoelectric signal is amplified through the signal amplifier 305 in the control section 301 shown in FIG. 5 and changes to an amplified signal.

At the same time, through the driving circuits 306x, 306y, and 306z in the control section 301, the YZ-direction driving VCMs 215yz and the XZ-direction driving VCMs 215xz in the objective unit 201 shown in FIGS. 4A-4C are driven by electromagnetic functions, and the objective lens 210 is position-controlled in the XYZ direction so that an arbitrary point, line, surface, or space of the object is sampled or scanned.

At the same time, in the control section 301 of FIG. 5, the image signal is produced, through the image producing circuit 307, from an amplifying signal delivered from the signal amplifier 305 and driving signals delivered from the X driving circuit 306x, the Y driving circuit 306y, and the Z driving circuit 306z, and is sent to the storage device 308 to record image information or to the monitor 303 through the monitor cable 302 to display an image. The image thus available is a confocal image.

In this case, when the knob 103 of the illumination and detection unit 101 shown in FIGS. 1 and 2A is operated to switch the confocal pinhole 113-a on the optical path in FIG. 2A to the non-confocal aperture 113-b, the focusing and defocusing components of the signal light 128-3 are detected at the same time, and a non-confocal image is obtained.

When the knob 102 of the illumination and detection unit 101 shown in FIGS. 1 and 2A is operated to remove the rectangular prism 110 in FIG. 2A out of the optical path 9, and the revolver 3 of the microscope 1 in FIG. 1 is operated to switch the objective unit 201 situated on the optical path 9 to the ordinary objective lens 7, an ordinary microscope observation becomes possible through the eyepiece 5 as in a conventional microscope.

Next, the effect of the first embodiment constructed as described above will be explained. According to the objective unit 201 of the first embodiment, only the axial beam of light is condensed and thus a spot of light in which aberration is minimized can be formed. Where the objective unit is mounted to the optical apparatus through the revolver 3 to construct a scanning optical apparatus, a scanning mechanism is not required for the optical apparatus itself, and therefore the entire optical apparatus can be downsized. The spot of light can be moved in a plane normal to the optical axis and along the optical axis, and the three-dimensional information of the specimen can be obtained. The illumination beam is introduced into the objective pupil, without the wane of the pupil, and the resolution and the amount of illumination light can be prevented from lowering extremely.

According to the objective scanning microscope having the objective unit of the first embodiment, the objective unit 201, like the ordinary objective lens 7, can be mounted to the revolver 3 of the microscope. Hence, when the objective unit 201 is placed on the optical path, the optical apparatus functions as a scanning microscope, while when the ordinary objective lens 7 is placed on the optical path, it functions as a conventional optical microscope for ordinary observation.

Furthermore, since the illumination and detection unit 101 has the shape of an intermediate lens barrel and the objective unit 201 assumes the shape of an objective lens, their mounting to the microscope is extremely facilitated. The semiconductor laser oscillator 106 is used as a light source, and thus a small-sized, inexpensive system can be realized, compared with the case where a gas laser is used.

Since an objective scanning system is applied, the region of an image formed by the objective lens is limited to only an area close to the axis. That is, for the imaging characteristic of the objective lens, it is only necessary to correct aberration only in the area close to the axis, and therefore an image of good quality can be obtained even by a simple lens system of a small number of lenses. Moreover, the design and manufacture of such a lens system are easy. For a similar reason, the size and weight of the objective lens are reduced, and the scanning speed can be considerably increased.

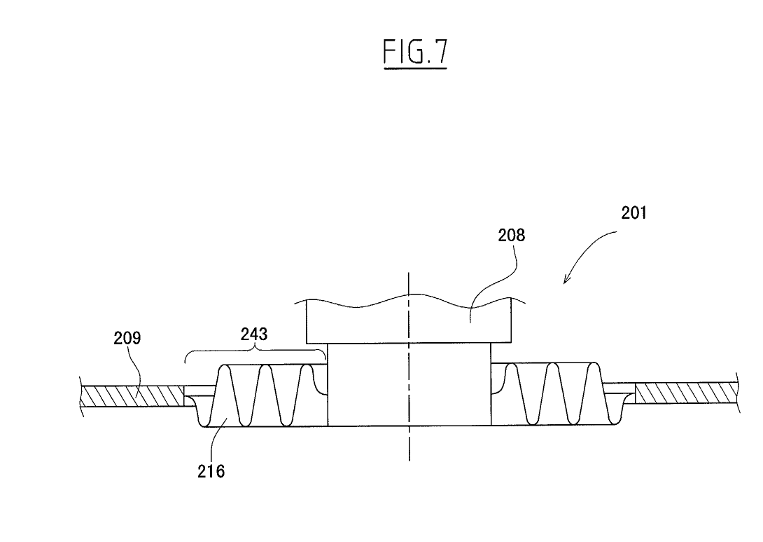

The modified example of the first embodiment is shown in FIG. 7, which indicates the top of the objective unit 201. Since parts other than those shown in this figure are the same as in the first embodiment, their explanation is omitted. Here, the aperture 243 between the cover 209 and the objective frame 208 is blocked by a shield member 216 made with a film of elastic material. Whereby, foreign matter, such as a liquid, can be prevented from penetrating the interior of the objective unit 201 form the aperture 243, and hence even when the objective unit 201 is used as a liquid-immersion objective lens, there is no danger that the penetration of the liquid causes the failure of a mechanism inside the objective unit 201. In addition, since the shield member 216 has the shape of fins to increase its flexibility and elasticity, the increment of loads imposed on the VCMs 215xz and 215yz by the addition of the shield member 216 can be kept to a minimum.

As another modified example of the first embodiment, it is possible to use a piezoelectric element, such as a Stacked Piezoelectric Actuator, a bimorph piezoelectric actuator, or a unimorph piezoelectric actuator, not shown, for the actuator driving the objective lens 210 of the objective unit 201. The piezoelectric element, in contrast with the voice coil motor, is not suitable for the application that the lens is driven through a long stroke, but is suitable to drive the lens through a short stroke at a high speed. Therefore, it is peculiarly suitable for the application that a minute region is scanned at a high speed and is observed at a high magnification.

Second Embodiment

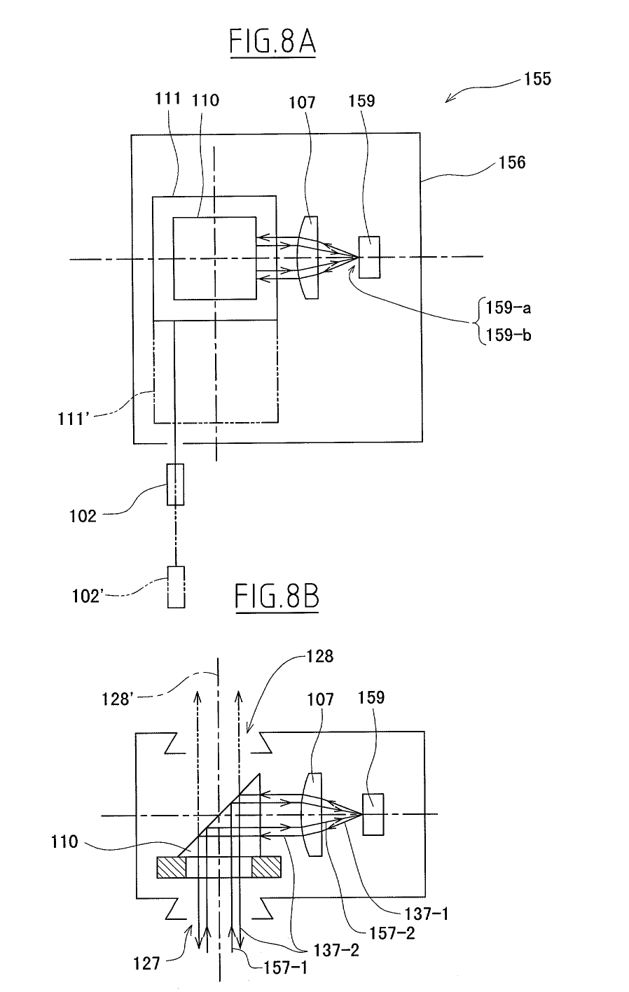

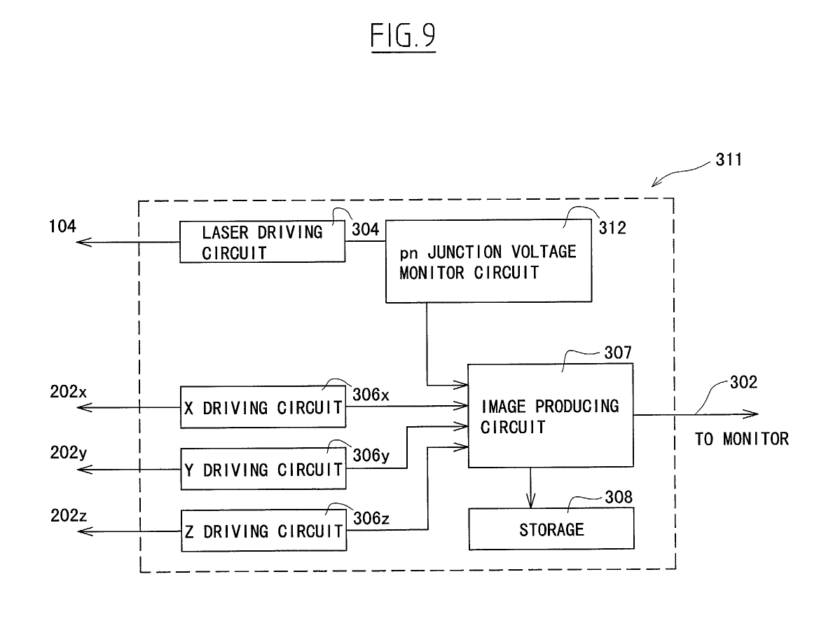

The second embodiment of the optical apparatus having the objective unit of the present invention is explained with reference to FIGS. 8A, 8B, and 9. In these figures, like numerals indicate like elements with respect to the first embodiment, and their explanation is omitted. Also, parts other than those shown in the figures of the second embodiment are the same as in the first embodiment.

An illumination and detection unit 155 of the second embodiment replaces the illumination and detection unit 101 of the first embodiment, and is constructed with a semiconductor laser oscillator 159 which combines a light source with a photodetector means. Also, it is the same as in the first embodiment that the wavelength of the divergent light 137-1 emitted from the semiconductor laser oscillator 159 is determined in accordance with its application. A control section 311 of the second embodiment replaces the control section 301 of the first embodiment, and is provided with a pn junction voltage monitor circuit 312.

Subsequently, the function of the second embodiment will be described. The LSM of the second embodiment is suitable for observations of industrial materials and products, such as semiconductors and metals. Moreover, it is also constructed as a so-called laser feedback microscope using a semiconductor laser element as a combination of a light source with a photodetector. This microscope is proposed by Juskaitis et al. (R. Juskaitis, N. P. Rea, and T. Wilson: Appl. Oct. 33 (1994), 578), and is reported in detail by Fujita et al. (K. Fujita and S. Kawada, “Laser Feedback Microscope Utilizing Threshold Control by Returned Light”, Laser Study, Vol. 24, No. 10, pp. 1084-1090). Here, the outline of the operating principle of the microscope will be given, together with the function of the second embodiment.

The LSM of the first embodiment, as shown in FIGS. 2A and 2B, is designed to introduce the signal light 128-1 into the silicon photodiode 148 so that it does not return to the semiconductor laser oscillator 106. In contrast to this, the LSM of the second embodiment, as shown in FIGS. 8A and 8B, is such that the total amount of parallel signal light 157-1 is incident on the semiconductor laser oscillator 159, as convergent signal light 157-2 which is returned light, through the prism 110 and the collimator lens 107. This returned light brings about a change in an oscillation state of the semiconductor laser oscillator 159.

On the other hand, the laser driving circuit 304 in the control section 311 shown in FIG. 9 is adapted to drive the semiconductor laser oscillator 159 with constant current. Under the above condition, a pn junction voltage variation Δv is proportional to an absolute value |s| of amplitude of the returned light (namely the signal light 157-1). Specifically, a value Δv² of the square of the voltage variation is proportional to an intensity s² of the signal light. Hence, the voltage variation Δv is monitored through the pn junction voltage monitor circuit 312, and thereby the intensity of the signal light 157 can be found. By inputting the intensity information of the signal light 157-1 thus available into the image producing circuit 307, a scanning microscope image can be obtained as in the first embodiment.

Not only is the area of an exit port 159-a of the semiconductor laser oscillator 159 shown in FIG. 8A extremely small, but it serves as an entrance port 159-b as it is, and thus an ideal confocal optical system is naturally constructed.

Next, reference is made to the effect of the second embodiment. According to the second embodiment, as mentioned above, the semiconductor laser oscillator 159 is used to combine the light source with the photodetector, and therefore the light splitting and combining member like the polarization beam splitter 108 or the quarter-wave plate 109 of the first embodiment becomes unnecessary. As a result, the number of parts constituting the illumination and detection unit 155 can be reduced, so that the construction of the illumination and detection unit becomes simple and a compact optical apparatus can be obtained.

At the same time, an ideal confocal optical system is constructed, and thus, in contrast to the conventional system that the signal light is separated from illumination light and is detected through a confocal pinhole by an independent photodetector, laborious work that the position of the confocal pinhole must be adjusted becomes unnecessary. Consequently, the cost of the apparatus itself can be kept to a minimum, and good information on the signal light can be obtained, that is, an apparatus of high performance can be achieved.

Third Embodiment

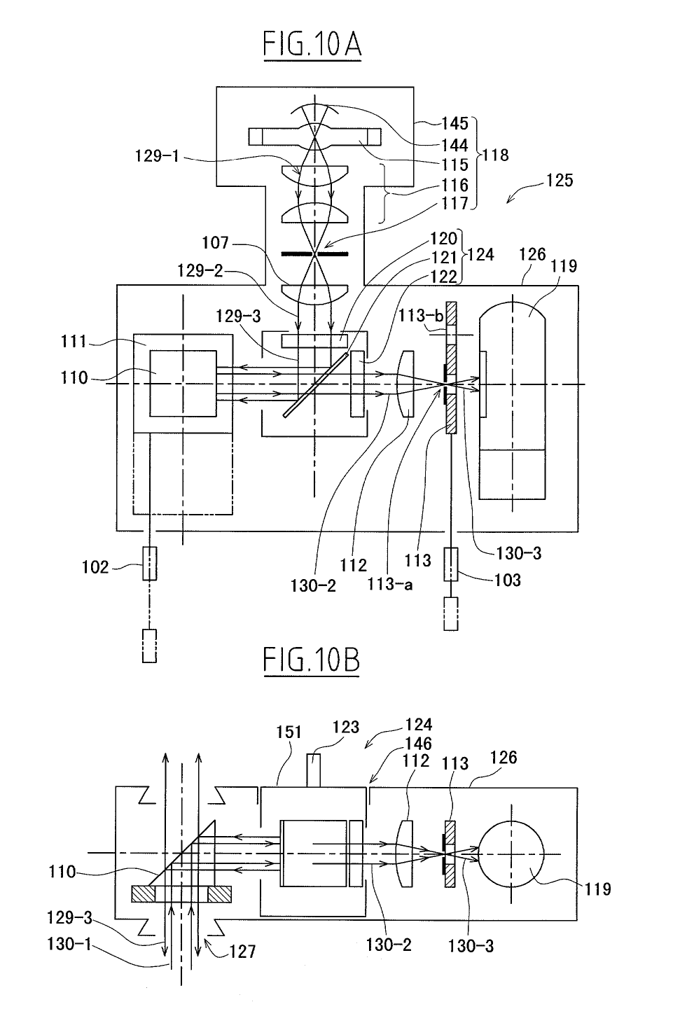

The third embodiment of the optical apparatus having the objective unit of the present invention is explained with reference to FIGS. 10A and 10B. The optical apparatus of this embodiment is constructed as a microscope suitable for fluorescence observation. In these figures, like numerals indicate like elements with respect to the above embodiments, and their explanation is omitted. Also, parts other than those shown in the figures of the third embodiment are the same as in the first embodiment. However, in the third embodiment, which does not use the semiconductor laser oscillator as the light source, the laser driving circuit 304 and the cable 104 in the control section 301 are not required.

An illumination and detection unit 125 of the third embodiment replaces the illumination and detection unit 101 of the first embodiment, and as shown in FIG. 10A, is constructed with a source device 118, a light splitting cassette 124, and a photomultiplier tube 119.

The source device 118 has a lamp house 145, a concave mirror 144, a mercury-vapor lamp 115, a collector lens 116, and a pinhole 117. The light splitting cassette 124 has an excitation filter 120, a dichroic mirror 121, and an absorption filter 122, and as shown in FIG. 10B, includes a knob 123 and a frame 151. An outer cover 126 of the illumination and detection unit 125 is provided with an aperture 146, through which the light splitting cassette 124 can be arbitrarily mounted and dismounted or replaced.

Subsequently, the function of the third embodiment will be explained. Wide-band illumination light 129-1 is emitted from the mercury-vapor lamp 115 and is collected on the pinhole 117 through the concave mirror 144 and the collector lens 116. Here, the wide-band illumination light 129-1 is transmitted through the pinhole 117 and the collimator lens 107 to thereby change to parallel illumination light 129-2, and after being incident on the excitation filter 120, becomes excitation light 129-3 which is narrowed to a desired wavelength region. In this case, the dichroic mirror 121 has the characteristics of reflecting wavelengths of the excitation light and of transmitting wavelengths of fluorescent light to be observed, and the excitation light 129-3 follows the same course as in the first embodiment to illuminate the specimen. When the specimen is illuminated, it emits auto-fluorescence or fluorescent light 130-1 in accordance with the property of fluorescent dye processed for the purpose of observation. The fluorescent light 130-1 follows an opposite course to the optical path of the illumination light and returns to the illumination and detection unit 125. The light is then transmitted through the dichroic mirror 121 so that the component of the excitation light is completely cut off through the absorption filter 122, and is collected, by the condenser lens 112, on the pinhole 113-a which constitutes a confocal system, together with the pinhole 117. Fluorescent light 130-3 of a focusing component transmitted through the pinhole 113-a is incident on the photomultiplier tube 119 and is converted into a photoelectric signal.

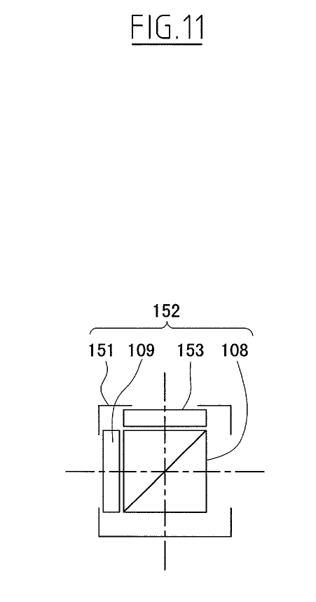

Next, the effect of the third embodiment will be explained. According to the third embodiment, a fluorescence confocal microscope is constructed and thus is suitable for the application of a fluorescent specimen, notably a biological specimen, to a three-dimensional observation. In particular, when a conventional beam scanning system is used, an objective lens for observing a fluorescence confocal image obtained by ultraviolet excitation must be corrected for aberration over a wide range from the ultraviolet region to the visible region, and from an on-axis area to an off-axis area. It is extremely difficult to design and manufacture such a lens. According to the third embodiment, however, since the objective scanning system is applied as in the first embodiment, light which passes through the objective lens is only axial light. That is, for the imaging characteristic of the objective lens, it is only necessary to correct aberration only in the area close to the axis, and therefore an image of good quality can be obtained even by a simple lens system of a small number of lenses. Moreover, the design and manufacture of such a lens system is easy. For a similar reason, the size and weight of the objective lens are reduced, and the scanning speed can be considerably increased. Also, it is needless to say that if various cassettes are used for the light splitting cassette 124, an excitation wavelength and a fluorescence wavelength can be arbitrarily selected and combined. Other effects are almost the same as in the first embodiment. The modified example of the third embodiment is described below. The optical apparatus of this modified example is such that the light splitting cassette 124 in FIGS. 10A and 10B, as depicted in FIG. 11, is replaced with a polarization beam splitter cassette 152. As shown in FIG. 11, the polarization beam splitter cassette 152 has the construction that an UV transmission filter 153, the polarization beam splitter 108, the quarter-wave plate 109, and a frame 151 are arranged as in the figure.

In the modified example, the parallel illumination light 129-2 transmitted through the source device 118, the pinhole 117, and the collimator lens 107, after being narrowed to the wavelength region of ultraviolet light through the UV transmission filter 153, follows the same course as in the first embodiment to illuminate the specimen. Reflected light therefrom follows the same course as in the first embodiment to enter the photo-multiplier tube 119 and is converted into a photoelectric signal. By this photoelectric signal, a reflecting sample, such as a metal or a semiconductor, can be observed, as a confocal image, through a control section and a monitor, not shown.

According to the modified example, by ultraviolet illumination (with a wavelength of 365 nm or 248 nm of the mercury-vapor lamp), observations can be carried out with higher resolution than that of the visible ray.

Fourth Embodiment

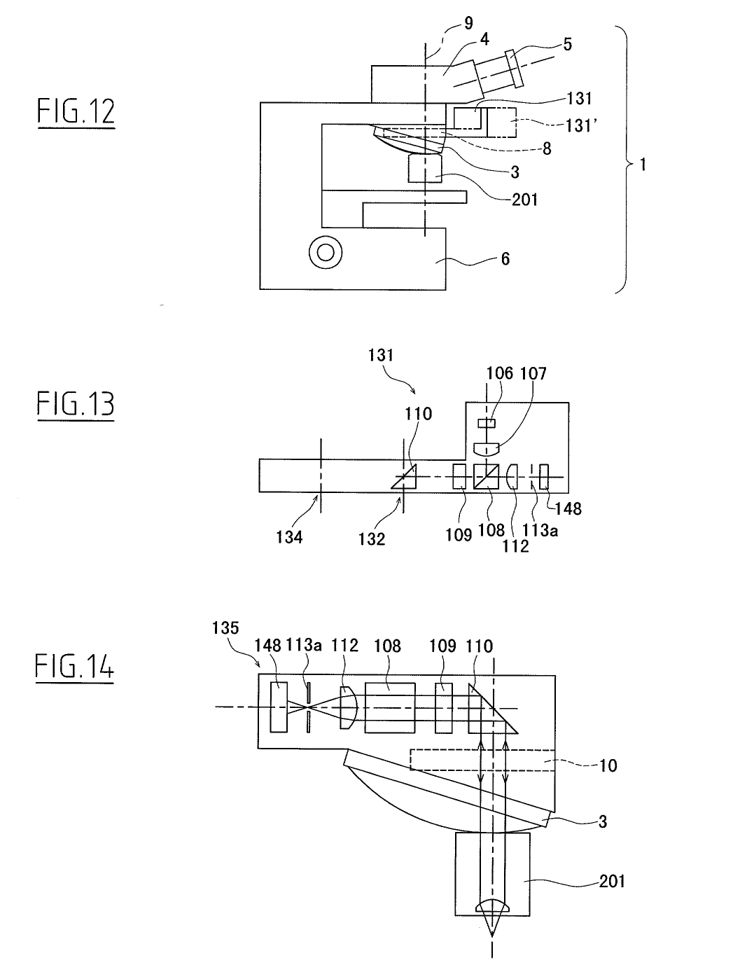

The fourth embodiment of the optical apparatus having the objective unit of the present invention is explained with reference to FIGS. 12 and 13. In these figures, like numerals indicate like elements with respect to the above embodiments, and their explanation is omitted. Also, parts other than those shown in the figures of the fourth embodiment are the same as in the above embodiments.

An illumination and detection unit 131 of the fourth embodiment replaces the illumination and detection unit 101 of the first embodiment, and as shown in FIG. 13, has the shape of a slider so that it can be inserted in a polarization filter slider hole 8 provided in the revolver shown in FIG. 12, for instance. The fundamental structure of the illumination and detection unit 131 in the fourth embodiment is the same as that of the first embodiment with the exception that the rectangular prism 110 depicted in FIG. 13 is fixed with respect to an illumination and detection path 132 and has a through path 134, separately from the illumination and detection path 132.

In the fourth embodiment, as shown in FIG. 12, when the illumination and detection unit 131 is inserted (as indicated by a solid line), the illumination and detection path 132 coincides with the optical path 9 of the microscope 1 so as to function as the illumination and detection unit. When the illumination and detection unit 131 is pulled out by half (as indicated by a broken line 131′), the illumination and detection path 132 is removed out of the optical path 9, and instead, the through path 134 coincides with the optical path 9 so that an ordinary microscope observation can be carried out.

According to the fourth embodiment, the illumination and detection unit 131, which is set only by making an insertion in the slider hole of the microscope body, can be used with great ease. Other effects are nearly the same as in the first embodiment.

Fifth Embodiment

The fifth embodiment of the optical apparatus having the objective unit of the present invention is explained with reference to FIG. 14. In this figure, like numerals indicate like elements with respect to the above embodiments, and their explanation is omitted. Also, parts other than those shown in the figure of the fifth embodiment are the same as in the above embodiments.

An illumination and detection unit 135 of the fifth embodiment is constructed so that it is integrally incorporated in the revolver, which can be replaced with the ordinary revolver 3 shown in FIG. 1. Although in FIG. 14 the semiconductor laser oscillator 106 and the collimator lens 107 are not shown, the internal structure of the illumination and detection unit 135 of the fifth embodiment is basically the same as that of the illumination and detection unit 101 of the first embodiment.

According to the fifth embodiment, the illumination and detection unit 135, which is set only by replacing the revolver of the microscope body, can be used with great ease.

Sixth Embodiment

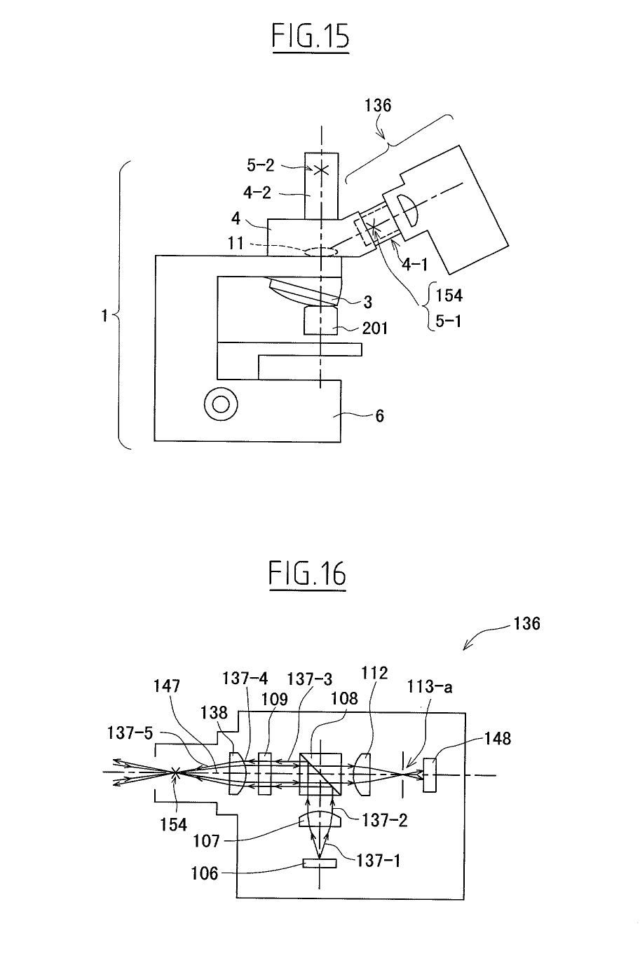

The sixth embodiment of the optical apparatus having the objective unit of the present invention is explained with reference to FIGS. 15 to 17. In these figures, like numerals indicate like elements with respect to the above embodiments, and their explanation is omitted. Also, parts other than those shown in the figures of the sixth embodiment are the same as in the above embodiments.

An illumination and detection unit 136 of the sixth embodiment, as shown in FIG. 15, is constructed so that it is of an eyepiece type and can be inserted in an eyepiece hole 4-1 of the lens barrel 4.

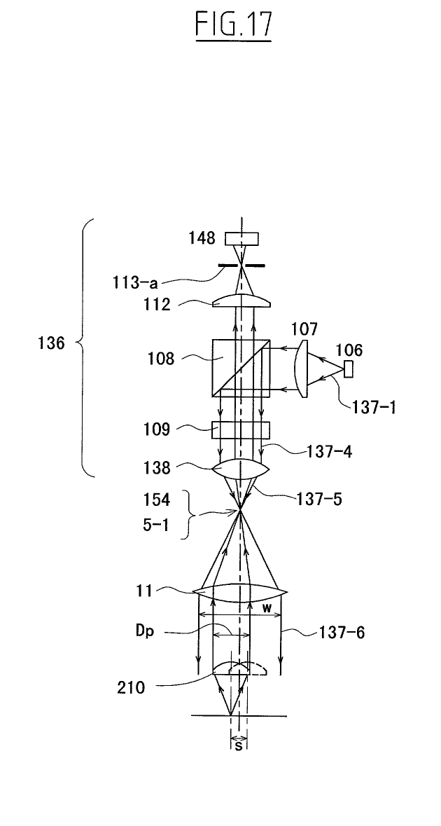

The function of the sixth embodiment is explained below. In the sixth embodiment, as illustrated in FIG. 16, the divergent light 137-1 emitted from the semiconductor laser oscillator 106 changes to the circularly polarized beam 137-4 through the collimator lens 107, the polarization beam splitter 108, and the quarter-wave plate 109, and is collected as convergent light 137-5 at a collecting point 154 by a relay lens 138. The collecting point 154, as shown in FIG. 17, coincides with the position of a primary image 5-1 formed by an imaging lens 11 of the microscope 1, and therefore the convergent light 137-5, when passing through the imaging lens 11, becomes a parallel beam 137-6, which is introduced into the pupil of an objective lens 210.

The parallel beam 137-6 illuminates a point of the specimen through the objective lens 210. Scattered and reflected light produced there follows an opposite course to the illumination light changes to linearly polarized light through the quarter-wave plate 109, and after being transmitted through the polarization beam splitter 108, is converted into a photoelectric signal by the silicon photodiode 148 through the condenser lens 112 and the confocal pinhole 113-a. By this photoelectric signal, the confocal image is obtained as in each of the above embodiments.

According to the sixth embodiment, the illumination and detection unit 136, which is set only by mounting it on the optical path of the eyepiece of the microscope body, can be used with great ease. Moreover, since the illumination and detection unit 136 is located on the exit side of the imaging lens 11, an image under the scanning optical microscope can be obtained, leaving an optical path 4-2 for a camera as it is.

The illumination and detection unit 136 of the sixth embodiment, although of the shape of an eyepiece as mentioned above, may be designed so that it has the shape of a camera and is mounted on the optical path 4-2 for a camera of the lens barrel 4 shown in FIG. 15. In this case, it is only necessary to cause the collecting point 154 shown in FIG. 17 to coincide with a camera imaging point 5-2 (the primary image position) by the imaging lens 11 in FIG. 15. Other structures and functions are the same as in the case of the shape of an eyepiece described above. Where the illumination and detection unit 136 is designed to have the shape of a camera, the illumination and detection unit 136, which is set only by mounting it on the optical path for a camera of the microscope body, can be used with great ease.

Seventh Embodiment

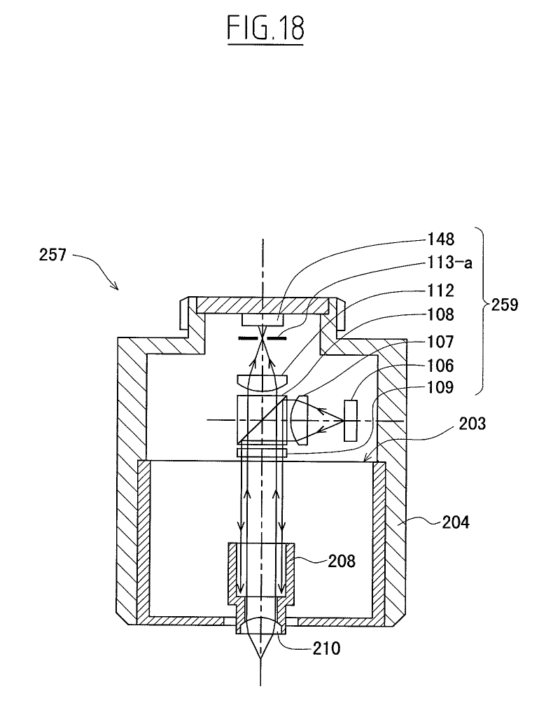

The seventh embodiment of the optical apparatus having the objective unit of the present invention is explained with reference to FIG. 18. In this figure, like numerals indicate like elements with respect to the above embodiments, and their explanation is omitted. Also, parts other than those shown in the figure of the seventh embodiment are the same as in the above embodiments.

In this embodiment, the functions of the illumination and detection unit and the objective unit are integrally provided in an objective type barrel, and thereby an objective scanning microscope unit is constructed so that it can be mounted to the revolver like the ordinary objective lens.

An objective scanning microscope unit 257 of the seventh embodiment is such that an illumination and detection section 259 and the objective component 203 are incorporated in the outer frame 204. Also, in FIG. 18, the interior of the objective component 203 is omitted.

According to the seventh embodiment, the objective scanning microscope unit 257, which is set only by mounting it to the revolver of the microscope body, can be used with great ease. Furthermore, since the objective scanning microscope unit 257 is provided with the light source, the scanning mechanism, and the detector, the scanning optical apparatus can be constructed only by mounting it to the optical apparatus through the revolver. The objective scanning microscope unit 257 functions to be optically completely independent of the microscope body, and thus it can be used, no matter whether the optical system of the microscope body is of an infinite correction type or of a finite correction type.

Moreover, since the light source and the detector are constructed separately from each other, the polarization beam splitter 108 and the quarter-wave plate 109 are replaced by the dichroic mirror 121 and the absorption filter 122, respectively, as in the third embodiment, and thereby a wavelength, such as fluorescent light, different from that of the light source can be detected.

Eighth Embodiment

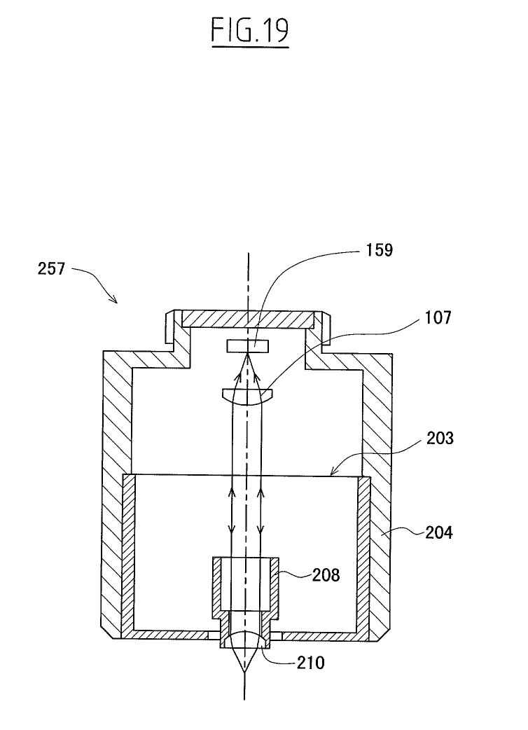

The eighth embodiment of the optical apparatus having the objective unit of the present invention is explained with reference to FIG. 19. In this figure, like numerals indicate like elements with respect to the above embodiments, and their explanation is omitted. Also, parts other than those shown in the figure of the eighth embodiment are the same as in the above embodiments.

In this embodiment, like the seventh embodiment, the functions of the illumination and detection unit and the objective unit are integrally provided in an objective type barrel, and thereby an objective scanning microscope unit is constructed so that it can be mounted to the revolver like the ordinary objective lens.

The objective scanning microscope unit 257 of the eighth embodiment is such that the outer frame 204 incorporates, as the illumination and detection section, the semiconductor laser oscillator 159 which combines the light source with the photodetector means, the collimator lens 107, and the objective component 203. Also, in FIG. 19, as in FIG. 18, the interior of the objective component 203 is omitted.

According to the eighth embodiment, like the seventh embodiment, the objective scanning microscope unit 257 is set only by mounting it to the revolver of the microscope body, and thus can be used with great ease. Furthermore, since the objective scanning microscope unit 257 is provided with the light source, the scanning mechanism, and the detector, the scanning optical apparatus can be constructed only by mounting it to the optical apparatus through the revolver. The objective scanning microscope unit 257 functions to be optically completely independent of the microscope body, and thus it can be used, no matter whether the optical system of the microscope body is of an infinite correction type or of a finite correction type. Since the light source also functions as the photodetector, the light splitting and combining member becomes unnecessary, and the objective unit can be downsized accordingly.

Ninth Embodiment

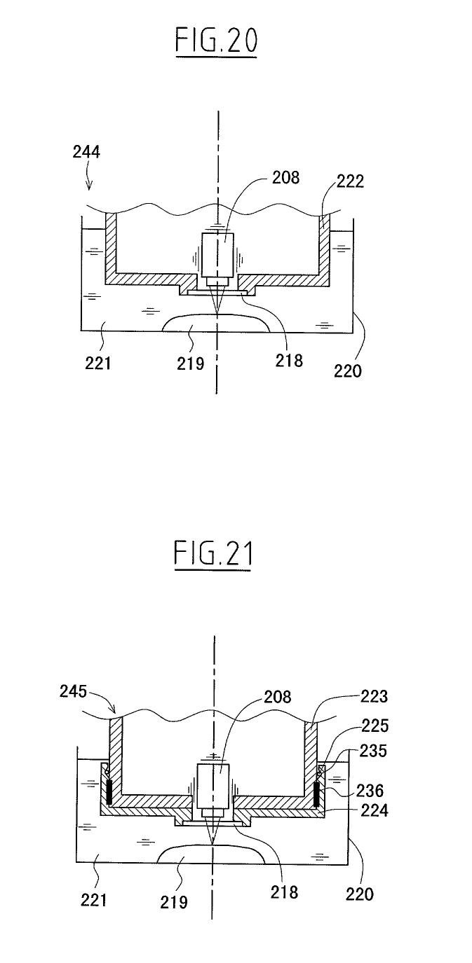

The ninth embodiment of the optical apparatus having the objective unit of the present invention is explained with reference to FIG. 20. The objective unit of this embodiment is constructed so that a liquid-immersion observation can be carried out. In this figure, like numerals indicate like elements with respect to the above embodiments, and their explanation is omitted. Also, parts other than those shown in the figure of the ninth embodiment are the same as in the above embodiments.

An objective unit 244 of the ninth embodiment has a plane-parallel glass plate 218 which forms a waterproof structure, together with an outer frame 222.

According to the ninth embodiment, vibration produced by the scan with the objective frame 208 is blocked by the plane-parallel glass plate 218 so that it is not transferred to a specimen 219 through a transparent liquid 221, such as water, in a vessel 220. Consequently, a stable specimen observation becomes possible and a sharp image of the specimen is obtained.

Tenth Embodiment

The tenth embodiment of the optical apparatus having the objective unit of the present invention is explained with reference to FIG. 21. The objective unit of this embodiment is constructed so that the liquid-immersion observation can be carried out. In this figure, like numerals indicate like elements with respect to the above embodiments, and their explanation is omitted. Also, parts other than those shown in the figure of the tenth embodiment are the same as in the above embodiments.

An objective unit 245 of the tenth embodiment is such that a top cover 224 which has the plane-parallel glass plate 218, an O-ring 225, an O-ring groove 235 and a screw 236 is fitted through the screw 236 to an outer frame 223, and thereby the waterproof structure is achieved.

According to the tenth embodiment, like the ninth embodiment, vibration produced by the scan with the objective frame 208 is blocked by the top cover 224 so that it is not transferred to the specimen 219 through the transparent liquid 221, such as water, in the vessel 220. Consequently, a stable specimen observation becomes possible and a sharp image of the specimen is obtained. In a non-liquid-immersion observation, by removing the top cover 224, the working distance of the objective lens can be optimized.

Eleventh Embodiment

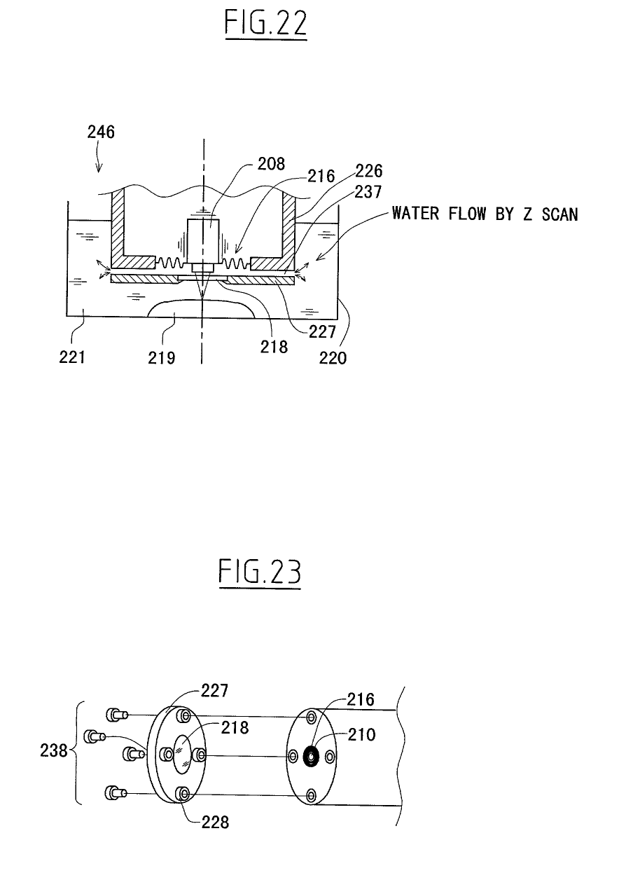

The eleventh embodiment of the optical apparatus having the objective unit of the present invention is explained with reference to FIGS. 22 and 23. The objective unit of this embodiment is constructed so that the liquid-immersion observation can be carried out. In these figures, like numerals indicate like elements with respect to the above embodiments, and their explanation is omitted. Also, parts other than those shown in the figures of the eleventh embodiment are the same as in the above embodiments.

An objective unit 246 of the eleventh embodiment, like the embodiment shown in FIG. 7, has a waterproof structure with the elastic film member 216. In addition, a disk member 227 provided with the plane-parallel glass plate 218 and legs 228 is mounted to an outer frame 226 by screws 238 and is held through a gap 237 corresponding to the height of each of the legs 228.

According to the objective unit 246 of the eleventh embodiment, when the liquid-immersion observation is carried out, a liquid penetrates into and fills in the gap 237 and thus the observation can be made with high NA. Moreover, vibration produced by the scan with the objective frame 208 is transferred to the gap 237 through the plane-parallel glass plate 218 and the disk member 227 to reach the periphery of the outer frame 226, and hence the vibration is not transferred directly to the specimen 219. Consequently, a stable observation becomes possible and a sharp image of the specimen is obtained.

In particular, when the specimen is scanned in the Z direction with the objective frame 208, the vibration brings about a heavy hydraulic fluctuation. Thus, if the portion of the elastic film member 216 is sealed and is shut out from the outside, the hydraulic fluctuation will offer strong resistance to a Z scanning drive. The eleventh embodiment is designed to escape the pressure of the vibration toward the outside, like the flow of a liquid, without sealing the portion of the elastic film member 216, and hence the Z scan in the liquid-immersion observation can be easily performed.

Twelfth Embodiment

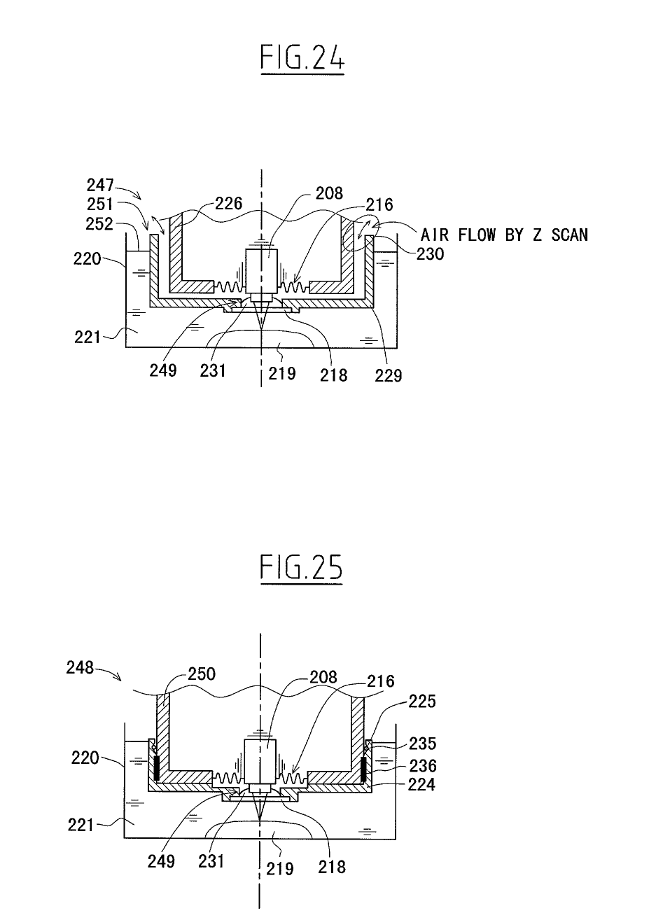

The twelfth embodiment of the optical apparatus having the objective unit of the present invention is explained with reference to FIG. 24. The objective unit of this embodiment is constructed so that the liquid-immersion observation can be carried out. In this figure, like numerals indicate like elements with respect to the above embodiments, and their explanation is omitted. Also, parts other than those shown in the figure of the twelfth embodiment are the same as in the above embodiments.

An objective unit 247 of the twelfth embodiment, like the embodiment shown in FIG. 7, has a waterproof structure with the elastic film member 216. In addition, a vessel-like member 229 provided with the plane-parallel glass plate 218 and the legs 228 (omitted from the figure of the twelfth embodiment), such as those shown in FIG. 23, is mounted to the outer frame 226. In the twelfth embodiment, a recess 249 is provided at the middle portion of the vessel-like member 229, and an aperture 251 of the vessel-like member 229 is extended upward so that it is located above a liquid level 252.

In the twelfth embodiment, the recess 249 is previously filled with a small quantity of transparent liquid 231, and the top of the objective frame 208 is immersed in the liquid to ensure the high NA. In addition, the elastic film member 216 is caused not to be filled with the liquid, and thereby the viscous drag of the liquid in the scan with the objective frame 208 can be reduced. Vibration produced by the XY scan or pressure varied by the Z scan can be escaped as an air flow 230 from the aperture 251.

Thus, according to the twelfth embodiment, as in the ninth to eleventh embodiments, the vibration produced by the scan with the objective frame 208 will not be transferred to the specimen 219, so that a stable specimen observation becomes possible and a sharp image of the specimen is obtained. As in the eleventh embodiment, the high NA of the objective lens can be ensured by the liquid immersion. Furthermore, since a moving part coming in contact with the liquid in the observation is only the top of the objective frame 208, the viscous drag of the liquid (notably, of oil) in the scan can be reduced, and a high-speed scan or a large-amplitude scan can be performed more easily than in the eleventh embodiment.

Thirteenth Embodiment

The thirteenth embodiment of the optical apparatus having the objective unit of the present invention is explained with reference to FIG. 25. The objective unit of this embodiment is constructed so that the liquid-immersion observation can be carried out. In this figure, like numerals indicate like elements with respect to the above embodiments, and their explanation is omitted. Also, parts other than those shown in the figure of the thirteenth embodiment are the same as in the above embodiments.

An objective unit 248 of the thirteenth embodiment, like the embodiment of FIG. 7, has a waterproof structure with the elastic film member 216. In addition, the top cover 224 similar to that of the tenth embodiment is mounted through the screw 236 to an outer frame 250. The top cover 224 of the thirteenth embodiment, as in the twelfth embodiment, has the recess 249, which is previously filled with a small quantity of transparent liquid 231, and the top of the objective frame 208 is immersed in the liquid to ensure the high NA. In addition, the elastic film member 216 is caused not to be filled with the liquid, and thereby the viscous drag of the liquid in the scan with the objective frame 208 can be reduced. The interior of the top of the top cover 224 exhibits the waterproof structure through the O-ring 225.

According to the thirteenth embodiment, as in the ninth to twelfth embodiments, the vibration produced by the scan with the objective frame 208 will not be transferred to the specimen 219, so that a stable specimen observation becomes possible and a sharp image of the specimen is obtained. As in the eleventh and twelfth embodiments, the high NA of the objective lens can be ensured by the liquid immersion. Furthermore, since a moving part coming in contact with the liquid in the observation is only the top of the objective frame 208, the viscous drag of the liquid in the scan can be reduced, and a high-speed scan or a large-amplitude scan can be performed more easily. In addition, the interior of the top of the top cover 224 exhibits the waterproof structure through the O-ring 225, and thus even when the specimen is placed in deep water, the observation can be made without any fear of water penetration.

Fourteenth Embodiment

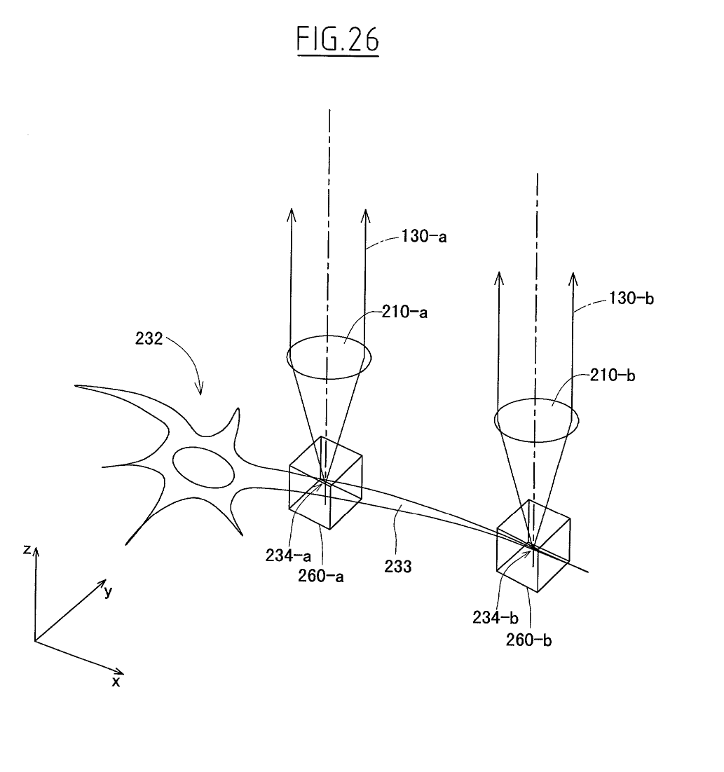

The fourteenth embodiment of the present invention is explained with reference to FIGS. 26-28. In these figures, like numerals indicate like elements with respect to the above embodiments, and their explanation is omitted.

In FIG. 26, reference numeral 232 represents a nerve cell; 233, a neuron; 234-a, a first observation point; 234-b, a second observation point; 260-a, a first observation space; 260-b, a second observation space; 130-a, signal light from the first observation point; 130-b, signal light from the second observation point; 210-a, a first objective lens; and 210-b, a second objective lens.

The optical apparatus of the fourteenth embodiment, as shown in FIG. 26, is capable of measuring the amounts of fluorescent light simultaneously at two observation points, for example, the first observation point 234-a and the second observation point 234-b, separated on the specimen. Furthermore, by scanning the specimen in the XYZ direction with the first objective lens 210-a and the second objective lens 210-b, the distributions of the amounts of fluorescent light in the first observation space 260-a and the second observation space 260-b, close to the two observation points, can also be measured.

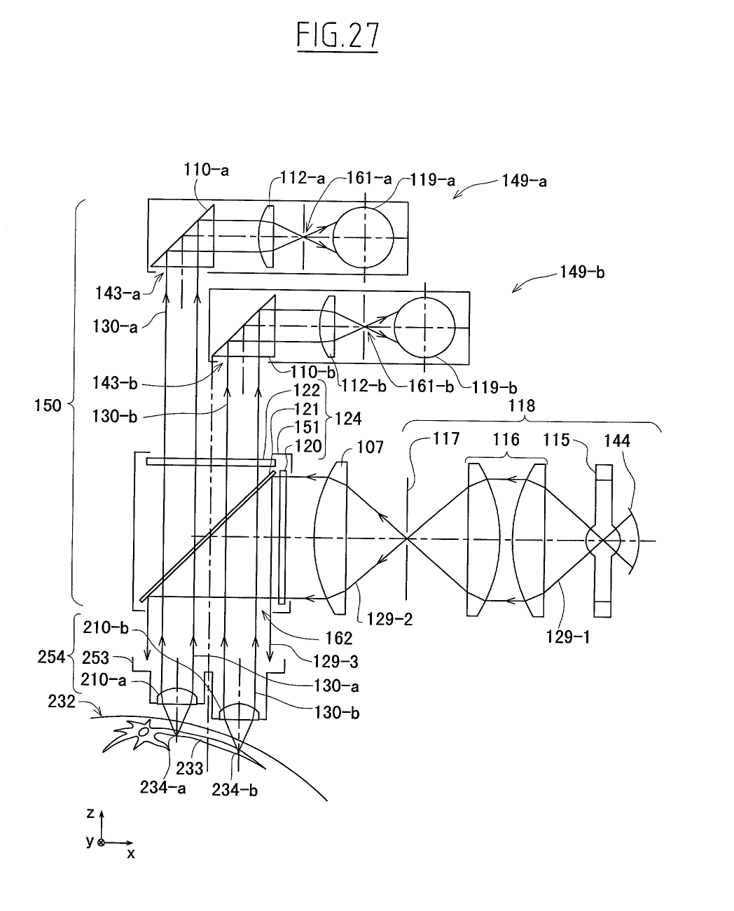

The specific construction of the fourteenth embodiment is described below, using FIG. 27. In this figure, reference numeral 150 denotes an illumination and detection unit and 254 denotes an objective unit. The illumination and detection unit 150 in the fourteenth embodiment has the source device 118, the collimator lens 107, and the light splitting cassette 124. These constructions of the source device 118, the collimator lens 107, and the light splitting cassette 124 are basically the same as those in the third embodiment shown in FIG. 10. The illumination and detection unit 150 includes two sets of photometric units, each having the rectangular prism 110, the condenser lens 112, the confocal pinhole 161, and the photomultiplier tube 119. These two sets of photometric units, which are exactly the same in construction, are distinguished by using subscripts a and b with respect to each numeral in the figure. Each of a first photometric unit 149-a and a second photometric unit 149-b has an XY-direction position adjusting mechanism (not shown).

The objective unit 254 includes the first objective lens 210-a, the second objective lens 210-b, and an XYZ-axis actuator 253. Apart from the XYZ-axis actuator 253, it has an XYZ-direction position adjusting mechanism (not shown). The XYZ-axis actuator 253 and the XYZ-direction position adjusting mechanism, for example, as shown in FIGS. 4A-4C, are provided with the XZ-direction driving VCMs, the YZ-direction driving VCMs, the parallel springs, and the spiral springs so that the first objective lens 210-a and the second objective lens 210-b are driven in the XYZ direction through the X driving circuit, the Y driving circuit, and the Z driving circuit of the control section, not shown.

Subsequently, a description is given of the function of the fourteenth embodiment. The wide-band illumination light 129-1 emitted from the mercury-vapor lamp 115 follows the same course as in the third embodiment and becomes the excitation light 129-3. The excitation light 129-3 is incident on the two objective lenses 210-a and 210-b previously positioned by the XYZ-direction position adjusting mechanism (not shown) so that the light is focused at the first observation point 234-a and the second observation point 234-b which are desired positions on the neuron 233. The light is collected at the two observation points 234-a and 234-b through the objective lenses 210-a and 210-b to excite fluorescent dye with which the nerve cell to be observed is previously stained. At this time, the first fluorescent light 130-a emanates from the first observation point 234-a and the second fluorescent light 130-b form the second observation point 234-b.

Individual fluorescent light passes through the objective unit 254 to return to the illumination and detection unit 150, and after being transmitted through the light splitting cassette 124, is incident on the first and second photometric units 149-a and 149-b. Through rectangular prisms 110-a and 110-b, condenser lenses 112-a and 112-b, and confocal pinholes 161-a and 161-b, the light is incident on photomultiplier tubes 119-a and 119-b for photometry. In this case, if the scan is not performed through the XYZ-axis actuator 253, simultaneous photometry of the first observation point 234-a and the second observation point 234-b becomes possible, while if so, sectional images in the first observation space 260-a and the second observation space 260-b will be obtained.

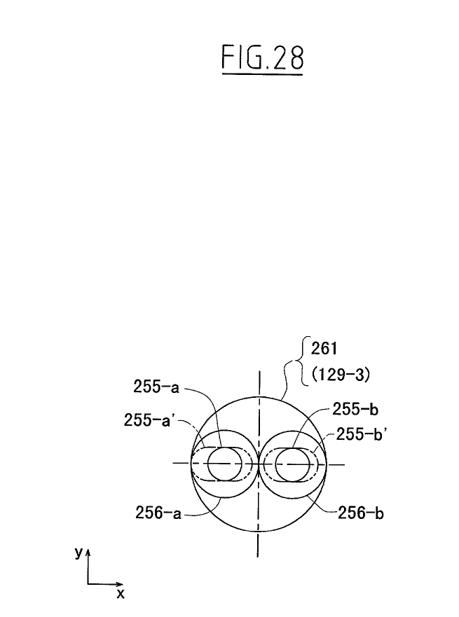

In the illumination and detection unit 150 of the fourteenth embodiment, the first photometric unit 149-a and the second photometric unit 149-b are positioned by the XY-direction position adjusting mechanism (not shown) so that the first signal light 130-a and the second signal light 130-b are incident on the first photometric unit 149-a and the second photometric unit 149-b, respectively. Using FIG. 28, this case is explained in detail.

In the figure, reference numerals 255-a and 255-b designate the pupils (objective pupils) of the first objective lens 210-a and the second objective lens 210-b, respectively, arranged in the X direction; 255-a′ and 255-b′ designate limits in which the objective pupil 255-a and the objective pupil 255-b are moved when the specimen is scanned in the X direction with the objective lens 210-a and the objective lens 210-b, respectively; and 256-a and 256-b designate aperture limits in which an effective aperture 143-a of the first photometric unit 149-a and an effective aperture 143-b of the second photometric unit 149-b are projected, parallel with the optical axis, on the surfaces of the objective pupil 255-a and the objective pupil 255-b, respectively. Reference numeral 261 designates an aperture limit in which an effective aperture 162 of the illumination system is projected, parallel with the optical axis, on the surfaces of the objective pupil 255-a and the objective pupil 255-b, and this limit coincides with a limit in which illumination beams can be introduced, without shortage, into the surfaces of the objective pupils 255-a and 255-b by the excitation light 129-3.

In FIG. 28, the effective aperture 256-a of the first photometric unit 149-a and the effective aperture 256-b of the second photometric unit 149-b are positioned without overlapping and so as not to protrude from the illumination introducing limit 261. The pupil moving limit 255-a′ in the X scan and the pupil moving limit 255-b′ in the X scan are determined so as not to protrude from the effective aperture 256-a of the first photometric unit and the effective aperture 256-b of the second photometric unit, respectively. When such positional relationships are established, the excitation light 129-3 is capable of introducing the illumination beams without eclipse of the bundle of light with respect to the pupils of the objective lenses 210-a and 210-b. Furthermore, the first signal light 130-a and the second signal light 130-b can be detected completely and without mixing with each other, through the first photometric unit 149-a and the second photometric unit 149-b, respectively.

Also, although reference has been made to the relationship between the objective pupils and the effective apertures of the photometric system and the illumination system in the case of the scan in the X direction, the same holds for the case of the scan in the Y or XY direction.

In the fourteenth embodiment, various combinations are possible in accordance with the purpose of the present invention in such a way that the light splitting cassette 124 is replaced as in the third embodiment, a semiconductor laser is used as a light source, or at least three sets of objective lenses and photometric units are provided to measure multiple points of more than three channels.

Alternatively, as a modified example of FIG. 27, the actuator 253 may be provided in each of the objective lenses. In this case, the scan can be controlled with respect to each objective lens, and hence the observation can be carried out under an optimum scanning condition in accordance with a part to be observed.

In the fourteenth embodiment also, when illumination such as that satisfying Condition (1) is provided, illumination light has a sufficient intensity, at least, within the limit in which each objective lens is moved, and therefore the illumination beam is introduce into the objective pupil, without shortage of the amount of light. Consequently, the resolution and the illumination intensity (the amount of illumination light) can be prevented from lowering extremely.

What is claimed is:

1. An objective unit comprising:
an objective lens;
objective holding means for holding said objective lens so that said objective lens can be spatially moved;
at least one actuator for driving said objective lens; and
an outer frame member for integrally supporting said objective lens, said objective holding means, and said actuator.

2. An objective unit according to claim 1, wherein light incident on said objective lens satisfies the following condition:
I_{off}/Iₒₙ≧0.135
where Iₒₙ is a light intensity at a center of illumination light and I_{off} is a light intensity at a position of a radius of d+Dp/2 from the center of said illumination light, where Dp is a pupil diameter of said objective lens and d is a maximum amount of movement of said objective lens moved by said actuator, that is, a distance from the center of said illumination light to an optical axis of said objective lens.

3. An objective unit according to claim 2, further comprising an element which combines a light source with a photodetector and a relay optical system which introduces light from said element into said objective lens and at the same time, introduces again signal light from a specimen, passing through said objective lens, into said element.

4. An objective unit according to claim 2, further comprising a light source, a photodetector, and a light splitting and combining member which introduces light from said light source into said objective lens and introduces signal light passing through said objective lens into said photodetector.

5. An objective unit according to claim 2, further comprising three sets of actuators so that a first actuator is placed to move said objective lens in a first direction, a second actuator is placed to move said objective lens in a second direction different from said first direction, and a third actuator is placed to move said objective lens in a third direction different from each of said first direction and said second direction.

6. An objective unit according to claim 2, wherein said outer frame member has a plane-parallel transparent member, said transparent member being placed at a top of said objective lens.

7. An objective unit according to claim 2, wherein said objective holding means holds a plurality of objective lenses.

8. An objective unit according to claim 7, wherein said outer frame member has a plurality of units, each including said objective lens, said objective holding means, and said actuator.

9. An optical apparatus having an objective unit, said objective unit comprising:
an objective lens;
objective holding means for holding said objective lens so that said objective lens can be spatially moved;
at least one actuator for driving said objective lens; and
an outer frame member for integrally supporting said objective lens, said objective holding means, and said actuator.

10. An optical apparatus according to claim 9, wherein light incident on said objective lens satisfies the following condition:
I_{off}/Iₒₙ≧0.135
where Iₒₙ is a light intensity at a center of illumination light and I_{off} is a light intensity at a position of a radius of d+Dp/2 from the center of said illumination light, where Dp is a pupil diameter of said objective lens and d is a maximum amount of movement of said objective lens moved by said actuator, that is, a distance from the center of said illumination light to an optical axis of said objective lens.

11. An optical apparatus according to claim 10, wherein said objective unit has an element which combines a light source with a photodetector and a relay optical system which introduces light from said element into said objective lens and at the same time, introduces again signal light from a specimen, passing through said objective lens, into said element.

12. An optical apparatus according to claim 10, wherein said objective unit has a light source, a photodetector, and a light splitting and combining member which introduces light from said light source into said objective lens and introduces signal light passing through said objective lens into said photodetector.

13. An optical apparatus according to claim 10, wherein said objective unit has three sets of actuators so that a first actuator is placed to move said objective lens in a first direction, a second actuator is placed to move said objective lens in a second direction different from said first direction, and a third actuator is placed to move said objective lens in a third direction different from each of said first direction and said second direction.

14. An optical apparatus according to claim 10, further having an illumination and detection unit including a light source, a photodetector, and a light splitting and combining member which introduces light from said light source into said objective lens and introduces signal light passing through said objective lens into said photodetector.

15. An optical apparatus according to claim 10, wherein a plane-parallel transparent member is placed at a top of said objective lens.

16. An optical apparatus according to claim 10, wherein said objective holding means holds a plurality of objective lenses, and said optical apparatus has beam diameter converting means for producing a light beam which is incident on all said plurality of objective lenses, and a plurality of photodetectors.

17. An optical apparatus according to claim 10, wherein said outer frame member has a plurality of units, each including said objective lens, said objective holding means, and said actuator.

18. An observation method using an optical apparatus which has an objective unit including an objective lens, objective holding means for holding said objective lens so that said objective lens can be spatially moved, at least one actuator for driving said objective lens, and an outer frame member for integrally supporting said objective lens, said objective holding means, and said actuator and which is provided with a plane-parallel transparent member at a top of said objective lens, so that a space between said transparent member and a specimen is filled with a transparent liquid medium to observe said specimen.

19. An observation method according to claim 18, wherein a space between said objective lens and said transparent member is filled with a different transparent liquid medium of substantially the same refractive index as a refractive index of said transparent liquid medium.
